(19) United States
(12) Patent Application Publication
(10) Pub. No.: US 2004/0206675 A1
(43) Pub. Date: Oct. 21, 2004

(54) Vehicle for classifying and collecting refuse

(75) Inventors: Toyoyuki Okamoto, Shimonoseki-shi (JP); Tokichi Fujimoto, Shimonoseki-shi (JP)

Correspondence Address: SUGHRUE MION, PLLC, 2100 Pennsylvania Avenue, NW, Washington, DC, 20037-3213, US

(73) Assignee: TOYO SYSTEM PLANTS CO., LTD

(21) Appl. No.: 10/387,585

(22) Filed: Mar. 14, 2003

(51) Int. Cl. B07B 1/49

(52) U.S. Cl. 209/421

(57) ABSTRACT

The present invention relates to a vehicle for classifying and collecting refuse, which is able to move various places such as a temporary refuse collecting place and sight-seeing spots, etc., crush and compact various kinds of classified refuse such as glass refuse, metals, and plastics per type, and accommodate the classified refuse per type, and simultaneously, is able to discharge per type the refuse accommodated by type, whereby refuse processing capacity and maintenance efficiency are excellent. The vehicle for classifying and collecting refuse comprises: a vehicle body having an installation base for which apparatuses are installed; a refuse processing apparatus portion, which is installed at the installation base for classifying, and crushing or compacting (reducing the capacity) refuse such as glass refuse, metals, plastic bottles, which are supplied through a refuse inputting portion; a refuse classifying/accommodating portion, which is inclinably installed at the rear part of the refuse processing apparatus portion, for classifying and accommodating the crushed or compacted refuse; a refuse discharging port formed at the rear side or the side of the refuse classifying/accommodating portion; and an inclination apparatus portion for inclining the refuse classifying/accommodating portion toward the rear side or the side of the vehicle body.

### BACKGROUND OF THE INVENTION

1. Field of the Invention

The present invention relates to a vehicle for classifying and collecting refuse, which is able to move to various places such as places where refuse is collected or sight-seeing spots, crush and compact various types of refuse such as empty bottles, plastic hangers, plastic vessels, styrene foam trays, plastic bottles, empty cans, etc., disposed from various living spaces such as households, public facilities, etc., classify and accommodate compacted and processed substances of various types of refuse, and collect the same.

2. Description of the Prior Art

Conventionally, refuse of used glass refuse, metals such as steel cans, aluminum cans, etc., plastics such as plastic bottles and plastic trays, etc., has been increased in line with prevalence in packages of beverages and foodstuffs, etc. Recently, classified collection of the refuse has been carried out in order to recycle the refuse as resources.

Refuse such as glass refuse, empty cans, plastic bottles, etc., which are discharged from households, public facilities, etc., is collected by a refuse collection vehicle having a refuse accommodating container and is transferred to a refuse processing facility, where the refuse is classified type by type and respective processes are performed.

However, there are such problems by which, since the refuse collected in a refuse processing facility is diversified and is of a large amount, a great deal of time and labor are required to classify the refuse type by type, and since the refuse is contained in vinyl bags, additional labor is also required to remove the vinyl bags.

Therefore, recently, classified refuse collection vehicles have recently been disclosed, which are able to classify type by type, collect and process used glass refuse and refuse such as steel cans, aluminum cans, and plastic bottles, etc., discharged from households, public facilities, etc.

For example, in Japanese Unexamined Patent Publication No. Hei-5-319505 (hereinafter called Publication “a”), a classified refuse collection vehicle is disclosed, which comprises; an accommodating container having the inside thereof sectioned by partitioning plates into a plurality of classifying/collecting chambers juxtaposed in the vehicle width direction, respective classifying/collecting chambers of which have a refuse supplying port at the upper part of the rearward opening portion, and having a refuse discharging port at the lower part thereof; a screw conveyor disposed at upper space of the respective classifying/collecting chambers of the accommodating container, which moves refuse supplied from the refuse supplying port of the classifying/collecting chambers to the front of the classifying/collecting chambers; a covering body for opening and closing the refuse discharging port, which is vertically openably and swingably mounted at the respective refuse discharging ports of the classifying/collecting chambers of the accommodating container; a cover drive mechanism for individually driving the respective covering bodies of the respective classifying/collecting chambers so as to open and close the same; an inputting container vertically openably and swingably mounted at the rear open port of the accommodating container and internally incorporating loading conveyors juxtaposed in a plurality corresponding to the classifying/accommodating chamber, into which refuse is inputted into a refuse supplying port of the respective classifying/collecting chambers of the accommodating container when opening and closing the rear opening portion of the accommodating container; and a dumping mechanism for dumping the accommodating container rearward.

In Japanese Unexamined Patent Publication No. Hei-8-277004 (hereinafter called Publication “b”), a movable type vehicle for classifying and collecting empty cans and empty bottles is disclosed, in which a box-shaped housing unit mounted on the carrier bed of a self-moving vehicle is sectioned into a collecting chamber and a power chamber, a classifying and collecting mechanism, which is able to classify and collect empty cans and empty bottles of the first refuse to be classified, including empty cans and empty bottles, inputted from the outside is secured in the above-described collecting chamber, and a hydraulic unit and a power unit such as a power source device, which actuate at least the above-described classifying and collecting mechanism, is provided in the above-described power chamber.

In Japanese Unexamined Patent Publication No. Hei-10-175703 (hereinafter called Publication “c”), a refuse collection vehicle is disclosed, which collects various kinds of refuse in a carrier box mounted on the vehicle frame, wherein while the above-described carrier box is sectioned forward and rearward or leftward and rightward, and a apparatus for inputting refuse collected in a bucket from upward of the above-described carrier box is provided rearward or sideward of the carrier box, a chute is provided on the upper part of the above-described carrier box, which leads refuse inputted from the above-described bucket into one chamber beyond the other chamber located leftward and rightward or forward and rearward thereof, and the above-described chute is constructed so as to be inclined to a retreated position upward of the reversed bucket.

However, the above-described prior art classified refuse collection vehicles have the following problems.

(1) In the classified refuse collection vehicle described in Publication “a”, since the vehicle is not provided with a mechanism for compacting and processing inputted refuse in response to the types thereof, a classifying/collecting chamber is large-sized because empty bottles and empty cans become bulky, wherein it is difficult to efficiently collect a large amount of refuse. Therefore, it is necessary for the vehicle to travel back and forth from places where refuse is collected to a refuse processing facility many times, and there is a problem for which work efficiency is not sufficient.

(2) Since the accommodating container, screw conveyor for moving refuse, inputting container in which the refuse is inputted, and dumping mechanism for dumping the accommodating container are fixed on the carrier bed, there is such a problem by which it is difficult to carry out maintenance of these components.

(3) Since a screw conveyor is required, which is for conveyance of refuse in order to move the refuse, which is inputted into the inputting container, in front of the classifying/collecting chamber, maintenance efficiency is not satisfactory, and a classified refuse collection vehicle is large-sized, wherein sharp turns are not enabled, and convenience is not satisfactory.

(4) Since a loading conveyor disposed at the rear part of the accommodating container and a screw conveyor disposed in the accommodating container are provided, the weight of the accommodating container is increased, wherein, when the accommodating container is dumped to the rear side of the vehicle body, there is such a problem by which an excessive load is applied to the dumping mechanism and easy drive thereof is not enabled.

(5) In a movable type vehicle for classifying and collecting empty cans and empty bottles, which is described in Publication “b”, since empty cans and empty bottles are classified in a bulky state in the collecting chamber, a considerably wide space is occupied, and at the same time, the classifying and collecting mechanism is complicated, wherein there is such a problem for which productivity and work efficiency thereof are deficient.

(6) Since the power chamber and collecting chamber are not easily separated from each other, there is such a problem by which repair work becomes difficult when these are out of order, and maintenance thereof becomes inefficient.

(7) Since a refuse collection vehicle described in Publication “c” is not provided with compacting apparatuses respectively corresponding to empty cans and empty bottles, there is such a problem for which collection efficiency of refuse and productivity are not satisfactory.

(8) Since it is necessary that a chute for inputting refuse into respective sections of the carrier box in response to the types thereof is moved, there is such a problem by which the mechanical structure becomes complicated, wherein productivity and maintenance efficiency become insufficient.

The present invention solves the above-described problems, and it is therefore an object of the invention to provide a vehicle for classifying and collecting refuse, which is able to move various places such as a temporary refuse collecting place and sight-seeing spots, etc., crush and compact various kinds of classified refuse such as glass refuse, metals, and plastics per type, and accommodate the classified refuse per type, and simultaneously, is able to discharge per type the refuse accommodated by type, whereby refuse processing capacity and maintenance efficiency are excellent.

### SUMMARY OF THE INVENTION

In order to achieve the above-described object, a vehicle for classifying and collecting refuse according to the invention includes the following construction.

A vehicle for classifying and collecting refuse according to a first aspect of the invention comprises a vehicle body having, at the rear part thereof, an installation base on which apparatuses are installed; a refuse processing apparatus portion for classifying, and crushing or compacting (reducing the capacity) one or more types of refuse of glass refuse, metals such as empty cans, plastics such as plastic bottles, which are supplied through a refuse inputting portion installed at the installation base; a refuse classifying/accommodating portion, which is inclinably installed at the rear part of the refuse processing apparatus portion on the installation base, for classifying and accommodating the refuse crushed or compacted by the refuse processing apparatus portion; a refuse discharging port formed at the rear side or the side of the refuse classifying/accommodating portion; and an inclination apparatus portion for inclining the refuse classifying/accommodating portion toward the rear side or the side of the vehicle body.

With such a construction, the following actions are brought about.

(1) Since the vehicle for classifying and collecting refuse is provided with a refuse processing apparatus portion and a refuse classifying/accommodating portion, the vehicle is able to move to a place of collecting refuse, classify and collect various kinds of refuse such as glass refuse, cans and plastic bottles at the place, and classify and accommodate the refuse while carrying out a classified refuse compacting process. Therefore, it is possible to efficiently transfer the refuse to a refuse processing facility per type.

(2) Since the refuse classifying/accommodating portion is installed at the installation base of the vehicle body equipped with an inclination apparatus portion so as to freely incline, if the refuse classifying/accommodating portion is only inclined with respect to the installation base of the vehicle body after various kinds of refuse compacted and processed by the refuse processing apparatus portion are filled in the refuse classifying/accommodating portion, various kinds of classified refuse can be discharged per type. Since no variation is mixed in the refuse, recycling efficiency of the refuse can be improved when recycling the refuse.

(3) Where various kinds of refuse compacted and processed by the refuse processing apparatus portion are concentrated at the front part side of the refuse classifying/accommodating portion since the refuse classifying/accommodating portion is installed at the installation base of the vehicle body equipped with an inclination apparatus portion so as to freely incline, various kinds of refuse inside the refuse classifying/accommodating portion can be moved by inclining the refuse classifying/accommodating portion toward the rear part side by the inclination apparatus portion, and it is possible to prevent a partial concentration of the refuse from occurring.

(4) Since the refuse classifying/accommodating portion is disposed at the rear part of the refuse processing apparatus portion installed at the installation base, the distance between the refuse processing apparatus portion and the refuse classifying/accommodating portion can be shortened. Accordingly, it is possible to easily transfer the processed substances from the refuse processing apparatus portion to the refuse classifying/accommodating portion after the refuse is classified and crushed, and at the same time, it is possible to achieve small-sizing of a transfer apparatus required for transfer of the processed substances.

(5) Since the refuse classifying/accommodating portion is completely separated from the refuse processing apparatus portion, respective classified refuse accommodating portions with a simple structure can be formed without any drive portion, etc., at the refuse classifying/accommodating portion. Therefore, load of the inclination apparatus portion, which causes the refuse classifying/accommodating portion to be inclined toward the rear side of the vehicle body in a processing facility, can be relieved, wherein it is possible to easily and efficiently discharge the processed substances.

Herein, glass refuse including glass bottles, glass cases, glass such as window glass, etc., metals including aluminum cans, steel cans, small-sized metal components, etc., plastics including plastic bottles, plastic hangers, styrene foam trays, plastic trays, etc., paper and cloth wares including wastepaper, old magazines, used wrapping or packaging paper, clothing, etc., may be listed as refuse. Also, where refuse such as plastic hangers contains metallic parts, the metallic parts are first removed, and plastics and metals are respectively inputted into the different refuse inputting portions of the refuse processing apparatus portion.

The refuse processing apparatus portion is able to crush, compact and deform refuse, which is supplied from the outside, by a rotating blade and hammer in response to the character and kind thereof. For example, a glass refuse processing apparatus which crushes hard glass refuse and a non-glass refuse processing apparatus portion suitable for processing comparatively deformable non-glass substances are included in the refuse processing apparatus portion.

Further, where a lifting device, etc., is provided at the upper side of the upper wall or side wall of the refuse processing apparatus portion, and the refuse processing apparatus portion is detachably disposed with respect to the installation base, the refuse processing apparatus portion is lifted by using a crane apparatus, etc., and is conveyed to another place where repair and maintenance can be easily carried out.

Since noise generated by crushing glass refuse can be prevented from leaking outside if a noise-proof member is laminated or disposed on the inner wall of the refuse processing apparatus portion, this is favorable.

The refuse classifying/accommodating portion is a container which is able to classify and accommodate refuse crushed by the refuse processing apparatus portion, and the interior of the container may be divided, for use, into one or a plurality of sections as necessary.

Where a window is formed on the upper wall or side wall of the refuse accommodating portion, it is possible to observe the inside of the respective accommodating portions from the outside, wherein it is possible to easily check the quantity of the respective processed substances accommodated in the respective accommodating portions from the outside.

The inclination apparatus portion may be used for, for example, a vehicle with an inclination apparatus portion of a so called dump vehicle having a dumping feature, wherein, for example, the refuse accommodating portion may be inclined rearward or sideward of the vehicle by hydraulic power using P.T.O (Power Take-Off) as a drive source. Also, the refuse accommodating portion inclined at this time is pivoted at the installation base at the bottom side.

In addition, the inclination apparatus portion may have a rod-like reinforcement member, etc., which connects the installation base and the bottom wall of the refuse classifying/accommodating portion to each other, so that the refuse classifying/accommodating portion is not quickly moved to the installation base side due to a quick decrease in hydraulic power in a cylinder when the refuse classifying/accommodating portion is inclined. Accordingly, it is possible to prevent the refuse classifying/accommodating portion from quickly moving from its inclined state to its horizontal state, wherein it is possible to increase safety in operation. Also, if the reinforcement member may be devised so as to be used only as necessary by one end thereof being pivotally supported so as to freely turn at the installation base, use efficiency will become excellent.

Also, by providing the refuse discharging port at the side part of the refuse classifying/accommodating portion, the refuse classifying/accommodating portion, may be inclined sideward by the inclination apparatus portion, wherein even in a place where wide space for discharging collected and processed refuse cannot be secured, the refuse can be easily discharged.

The refuse discharging port which is provided with an opening formed on the respective side walls or bottom walls of a plurality of sectioned accommodating portions and an opening and closing door openably disposed at the opening portion may be used. In addition, it is favorable that the opening and closing door is provided with a locking mechanism consisting of an engagement portion and a engaged portion. Therefore, only the opening and closing door of an accommodating portion in which refuse to be discharged is accommodated is opened, and the other opening and closing doors are closed and locked, wherein only the desired refuse may be discharged. Further, the opening and closing doors may be provided with a engaged portion, and an engagement portion with which the engaged portion is engaged when the opening and closing door is opened may be provided on the outer circumferential wall of the respective accommodating portions. Also, a supporting metal fitting which holds the opening and closing door in its open state may be disposed at the opening and closing door, wherein an open state of the opening and closing door can be maintained when processed substances in the respective accommodating portions are discharged, and it is possible to safely carry out discharge work without fail. Furthermore, where the refuse classifying/accommodating portion is inclined rearward, and the interior accommodated substances are discharged, an axially supporting portion which pivotally supports the opening and closing door at the rear side wall of the refuse classifying/accommodating portion at the upper side of the door is provided and the door is made into a hinged door opening upwards, wherein it is preferable that the opening and closing door is held in its open state by a supporting metal fitting. Then, it is possible to easily discharge the interior accommodated substances.

A screw conveyor may be used as a transfer apparatus for transferring substances crushed by the refuse processing apparatus portion to the refuse classifying/accommodating portion disposed at the rearward position, wherein it is possible to make even smaller the grain size of the crushed substances during the transfer by the screw conveyor.

The screw conveyor may include a screw having a shaft provided with spiral thread-like blades thereon and a pipe having screws incorporated therein.

The screw may be made of steel, wear-resistant steel plate, or a metal the surface of which is thermally sprayed to increase wear resistance.

The pipe may be made of a material having excellent wear resistance, for example, a carbon steel pipe for piping such as SGP, STPG, etc., a metal whose interior is thermally sprayed to increase wear resistance. Thereby, durability of the screw conveyor can be improved.

Also, pneumatic transfer which uses a fan, a blower, etc., may be used as means for transferring non-glass refuse crushed substances to the refuse classifying/accommodating portion. Also, a fluid conveyor such as an air conveyor, a belt conveyor, or a screw conveyor may be used. Where a blower is used, a rotary valve is employed at the lower part of a crusher for non-glass refuse, and a tube into which air exhausted from the blower is caused to communicate with the lower part thereof, wherein crushed substances are supplied from the upper part into a container in which rotating rotors of the rotary valve are disposed, and the crushed substances thus supplied are conveyed to the lower part of the container via between the impeller of the rotors and the container, wherein if the crushed non-glass substances are conveyed by air exhausted from the blower, the crushed substances are quantitatively separated and can be pneumatically conveyed. Therefore, it is possible to securely convey the processed substances.

The vehicle for classifying and collecting refuse according to a second aspect of the invention is featured, in addition to the first aspect, in that the refuse processing apparatus portion is provided with the refuse inputting portion at the left side of the vehicle body in the case where the vehicle body is for a left-hand side traffic system or at the right side of the vehicle body in the case where the vehicle body is for a right-hand side traffic system.

With such a construction, the following actions can be brought about in addition to those obtained by the first aspect.

(1) Since the refuse inputting portion of the refuse processing apparatus portion is formed at the left side of a vehicle body in the case where the vehicle body is for a left-hand side traffic system or at the right side thereof in the case where the vehicle body is for a right-hand side traffic system, the vehicle does not constitute a traffic hindrance and is able to quickly and safely collect various kinds of refuse placed on a road side. In particular, where the refuse inputting portion is located on the same side as that of the front passenger seat of the above-described vehicle for classifying and collecting refuse, a worker seated in the front passenger seat quickly gets out and is able to carry out collection-work, wherein work efficiency can be improved.

(2) Since the refuse inputting portion is provided only at one side of the vehicle body sides, the refuse processing apparatus portion installed at the installation base can be widened, and a wide space of the refuse processing apparatus portion can be secured, wherein convenience can be further improved.

The vehicle for classifying and collecting refuse according to a third aspect of the invention is featured, in addition to the first or second aspect, in that the refuse processing apparatus portion comprises one or more glass refuse processing apparatuses for crushing or compacting glass refuse, and/or one or more non-glass refuse processing apparatus portions for crushing or compacting metals such as empty cans or plastics such as plastic bottles, etc.

With such a construction, the following actions can be brought about in addition to those obtained by the first or second aspect.

(1) Since the refuse processing apparatus portion is provided with a glass refuse processing apparatus for crushing or compacting glass refuse and a non-glass refuse processing apparatus portion for crushing or compacting metals such as empty cans or plastics such as plastic bottles, it is possible to classify, and crush or compact glass refuse and non-glass refuse.

(2) Where two or more glass refuse processing apparatuses are provided, it is possible to classify and collect waste glass materials per type such as colored glass refuse, non-colored glass refuse, etc.

Here, it is preferable that the glass refuse processing apparatus and non-glass refuse processing apparatus portion include a crushing portion for crushing or compacting refuse inputted through the refuse inputting portion and a transfer apparatus for transferring substances processed by the crushing portion to the refuse classifying/accommodating portion. Thereby, only by inputting refuse in the refuse inputting portion, it is possible to crush or compact refuse and to classify and accommodate the refuse in the refuse classifying/accommodating portion, wherein a series of operations can be sequentially carried out simultaneously with input of refuse, and work time can be remarkably shortened.

The vehicle for classifying and collecting refuse according to a fourth aspect of the invention is featured, in addition to any one of the first through third aspects, in that the refuse classifying/accommodating portion includes: a glass refuse accommodating portion for accommodating glass refuse substances processed by the glass refuse processing apparatus; a glass refuse accommodating port formed at the upper wall or sidewall of the glass refuse accommodating portion, into which the glass refuse processed substances are supplied; a glass refuse discharging port formed at the side wall or the rear wall of the glass refuse accommodating portion; one or more classified refuse accommodating portions for classifying and accommodating non-glass refuse processed substances such as empty cans and plastic bottles, etc., which are processed by the non-glass refuse processing apparatus portion; a classified refuse accommodating port formed at the side wall or the upper wall of the classified refuse accommodating portion, into which the non-glass refuse processed substances are supplied; and a classified refuse discharging port formed at respective side walls or the respective rear wall of the classified refuse accommodating portion.

With such a construction, the following actions can be brought about in addition to those in any one of the first aspect through the third aspect.

(1) Since the refuse classifying/accommodating portion is sectioned by the glass refuse accommodating portion and one or more classified refuse accommodating portions and these portions are connected to the refuse processing apparatus portion via a detachable connection tube, the classified refuse accommodating portions are changed in response to the fitting relation with the discharging port secured at the refuse processing apparatus portion side and the accommodation quantity of the classified refuse accommodating portions, and the refuse can be efficiently crushed and classified.

(2) Where a glass refuse accommodating port is provided in the upper wall of the glass refuse accommodating portion, glass refuse processed substances having comparatively heavy specific gravity are easily and uniformly inputted therethrough to prevent the processed substances from being partially concentrated, wherein the accommodation efficiency of glass refuse accommodating portion can be increased.

(3) Where the glass refuse accommodating portion and classified refuse accommodating portion are installed at the installation base with the lengthwise direction thereof made parallel to the advancement direction of the vehicle, no dead space is formed when pneumatically discharging the processed substances to the above-described refuse classifying/accommodating portion, wherein scraps of cans and plastic bottles, etc., can be efficiently classified and accommodated.

Herein, the glass refuse accommodating portion and classified refuse accommodating portions, which are formed by sectioning the refuse classifying/accommodating portion, may be constructed so that the bottom walls thereof are made into inclination walls inclined toward the glass refuse discharging port side and classified refuse discharging port side, wherein respective processed substances inputted through the glass refuse accommodating port and classified refuse accommodating port can be naturally collected at the respective discharging port sides, and the respective processed substances can be smoothly discharged.

Also, the inclination walls are formed with a larger angle than the repose angle of respective processed substances such as glass refuse, cans, and plastic bottles, wherein, after the respective processed substances are inputted into the respective accommodating portions, the respective processed substances can be naturally moved to the bottom wall side.

In particular, in the case where the angle of the inclination walls is smaller than the repose angle, the respective processed substances may be accumulated on the inclination wall and at the inclination portions, and the respective processed substances cannot be naturally and smoothly collected to the discharging port side. Further, where the inclination angle is excessively larger than the repose angle, the classified refuse accommodating portion becomes higher, wherein the above-described refuse classifying/accommodating portion is likely to be large-sized. Neither of these is preferable.

Instead of forming the glass refuse accommodating portion and classified refuse accommodating portions by sectioning the refuse classifying/accommodating portion by partitioning walls, the glass refuse accommodating portion and classified refuse accommodating portion may be formed by connecting and uniting a plurality of accommodating chambers after the chambers are prepared in advance.

In addition, the glass refuse accommodating port and classified refuse accommodating ports are formed of openings drilled at the respective accommodating portions.

The vehicle for classifying and collecting refuse according to a fifth aspect of the invention is featured, in addition to any one of the first aspect through the fourth aspect, in that the refuse classifying/accommodating portion includes one or more glass refuse accommodating portions and/or one or more classified refuse accommodating portions, which are sectioned and formed in parallel to or orthogonal to the advancement direction of the vehicle body.

With such a construction, the following actions can be brought about in addition to those obtained by any one of the first aspect through the fourth aspect of the invention.

(1) Since the refuse classifying/accommodating portion is provided with one or more glass refuse accommodating portions and/or one or more classified refuse accommodating portions, which are formed by being sectioned in parallel to or orthogonal to the advancement direction of the vehicle body, supplying ports may be secured at the front side or one side of the respective accommodating portions, and further discharging ports may be secured at the rear part side or the other side thereof, wherein refuse can be accommodated in response to the classes of refuse, and post-processing can be carried out per type to improve work efficiency.

(2) Since the respective accommodating portions are sectioned in parallel to or orthogonal to the advancement direction of the vehicle body, accommodated refuse can be prevented by being caught in the interior of the accommodating portions and can be securely discharged by inclining the refuse classifying/accommodating portion rearward or sideward by the inclination apparatus portion.

The vehicle for classifying and collecting refuse according to a sixth aspect of the invention is featured, in addition to any one of the third aspect through the fifth aspect, in that the glass refuse processing apparatus comprises: a glass refuse crushing portion; a glass refuse crushed substance discharging port formed to be roughly funnel-like at the lower part of the glass refuse crushing portion; a glass refuse supplying portion formed at the upper part of the glass refuse crushing portion; a glass refuse inputting portion opened at the upper part or side wall of the refuse processing apparatus portion and communicating with the glass refuse supplying portion; and a glass refuse transfer portion communicating with the glass refuse crushed substance discharging port, the discharging port side of which is connected to the glass refuse accommodating port of the glass refuse accommodating portion of the refuse classifying/accommodating portion.

With such a construction, the following actions can be brought about in addition to those obtained by any one of the third aspect through the fifth aspect.

(1) Since the refuse processing apparatus portion is provided with a glass refuse processing apparatus, glass refuse inputted through the refuse inputting portion can be easily and effectively crushed by the glass refuse crushing portion that is able to crush in response to the characteristics of glass refuse.

(2) Where the glass refuse transfer portion is a screw conveyor formed of a metallic pipe and a screw internally mounted in the pipe, crushed glass refuse is further crushed during transfer and can be accommodated in the refuse classifying/accommodating portion of a subsequent glass refuse accommodating portion, wherein glass refuse processed substances can be prevented from becoming bulky in the glass refuse accommodating portion, and accommodation efficiency can be further improved.

(3) Since the refuse processing apparatus portion is provided with a belt conveyor and a transfer apparatus having a spiral mechanism, which convey glass refuse, processed glass refuse can be efficiently conveyed to the refuse classifying/accommodating portion installed at a rearward position.

(4) By forming the crushed substance discharging side of the glass refuse crushing portion roughly funnel-like, it is possible to prevent glass refuse substances crushed by the glass refuse crushing portion from being accumulated in the crushed substance discharging port, and the crushed glass refuse substances can be supplied to the transfer apparatus and refuse classifying/accommodating portion.

Herein, the following apparatuses may be used as a glass refuse crushing portion. That is, these are an apparatus that crushes glass refuse between a pair of comb-shaped glass refuse crushing portions by rotating the glass refuse crushing portions, an apparatus that presses and crushes glass refuse by a pressing and crushing tool, an apparatus that crushes glass refuse by inputting glass refuse from upward while rotating a roller-shaped glass refuse crushing portion, which has a crushing blade on the surface thereof, on the bottom portion having slits and holes, an apparatus that crushes glass refuse through rotations of a roughly cylindrical rotating body having a plurality of crushing blades disposed roughly parallel to a rotating shaft on the circumferential wall thereof by inputting glass refuse in the interior of the rotating body while rotating crushing blades secured on the rotating body, and an apparatus that crushes glass refuse by a plurality of chains while rotating respective rotating shafts, to which one end of the chains is connected, on the bottom board having slits. For example, an impact crusher which is provided with an impact blade attached to a high-speed rotating cylinder and a fixed blade facing the impact blade, and crushes and breaks refuse, and a hammer mill having an impact blade which is made rotatable by a hinge, etc., may be used.

The bottom portion on which glass refuse crushed by the glass refuse crushing portion is accumulated is formed so that the inclination angle of the wall surface at the discharging side thereof is larger than the repose angle of the glass refuse crushed substances, wherein the crushed substances can be supplied to the subsequent refuse classifying/accommodating portion by using the transfer apparatus without accumulating glass refuse crushed substances. In particular, where the inclination is smaller than the repose angle of the glass refuse crushed substances, the glass refuse crushed substances are likely to be accumulated on the side wall of the glass refuse crushing portion, and where the inclination is excessive, the glass refuse crushing portion is made higher to cause the apparatus to be made large. Neither of these is preferable.

A crosspiece-attached conveyor and a screw conveyor may be used as the glass refuse transfer portion. Also, in regard to connection of the glass refuse accommodating port of the glass refuse accommodating portion of the refuse classifying/accommodating portion and the discharging port of the glass refuse transfer portion, it may be sufficient that the discharging port is positioned upward of the glass refuse accommodating port. Also, a cover may be disposed between the discharging port and the glass refuse accommodating port. Therefore, dust and stains can be prevented from being discharged between the discharging port and the glass refuse accommodating port when discharging the glass refuse crushed substances.

Also, where colored glass and non-colored glass are classified and collected, the glass refuse crushing portion and glass refuse transfer portion may be separately provided. In this case, the refuse classifying/accommodating portion includes a plurality of glass refuse accommodating portions which can separately accommodate crushed substances of colored glass and non-colored glass crushed by the respective glass refuse crushing portions.

The vehicle for classifying and collecting refuse according to a seventh aspect of the invention is featured, in addition to the sixth aspect, in that the refuse processing apparatus portion comprises a bucket into which glass refuse is inputted through the glass refuse inputting portion and a bucket conveyor for transferring the bucket to the glass refuse supplying portion.

With such a construction, the following actions can be brought about in addition to those obtained by the sixth aspect.

(1) Since a bucket conveyor for elevating and lowering buckets is disposed in the refuse processing apparatus portion, glass refuse is inputted into a bucket when it is positioned at the lower part of the outer wall of the refuse processing apparatus portion, wherein it becomes possible to easily and safely transfer a great deal of glass refuse by actuating the bucket conveyor.

(2) Since the buckets can be moved with glass refuse held, glass refuse is not broken and scattered during the transfer, wherein collection work of refuse including glass refuse can be safely carried out.

Herein, it is preferable that means for detecting arrival of buckets is disposed at prescribed positions of the upper end part and lower end part of the bucket conveyor. Using the detecting means, it is possible to cause buckets to stop at prescribed positions of the upper end part and the lower end part.

Also, a proximity sensor, photoelectric sensor, limit switch, button switch, etc., may be used as the detecting means. In particular, in the case of a proximity sensor, since arrival of buckets can be detected by magnetism at both ends of the buckets only by forming the upper end part and lower end part of the buckets of a magnetic body such as steel, the proximity sensor can be prevented from erroneous operation due to dust and stains as in the photoelectric sensor, and it has environment resistance. Also, the proximity sensor is freed from trouble due to rust as in the limit switch and button switch. Therefore, the proximity sensor can be preferably used since it has excellent durability.

The vehicle for classifying and collecting refuse according to an eighth aspect of the invention is featured, in addition to the sixth or seventh aspect, in that the glass refuse transferring portion comprises a glass refuse connection tube communicating with the glass refuse crushed substance discharging port and disposed at the rear side of the refuse processing apparatus portion; a glass refuse movable tube communicating with the glass refuse accommodating portion, set and fixed at the front side of the refuse classifying/accommodating portion, and connected to the tip end portion of the connection tube by being brought into contact with the tip end portion of the connection tube when the refuse classifying/accommodating portion is installed at the installation base.

With such a construction, the following actions can be brought about in addition to those obtained by the sixth aspect or the seventh aspect.

(1) Since crushed and compacted glass refuse is transferred to the glass refuse accommodating portion by a glass refuse connection tube and a glass refuse movable tube detachably connected to the glass refuse connection tube, the glass refuse movable tube attached to the supplying port of the refuse classifying/accommodating portion is separated from the glass refuse connection tube and moves upward together with the refuse classifying/accommodating portion by causing the refuse classifying/accommodating portion to be inclined with respect to the installation base of the vehicle body. Therefore, there is no need to detach the glass refuse connection tube and glass refuse movable tube when discharging crushed-substances accommodated in the refuse classifying/accommodating portion wherein it is easy to carry out discharging work.

Also, connection portions of the glass refuse connection tube and the glass refuse movable tube are, respectively, formed to be horizontal, wherein the connection portions can be smoothly detached from the refuse classifying/accommodating portion without being caught by the refuse classifying/accommodating portion when being detached therefrom. In addition, a cover that covers up a part of the side wall in the vicinity of the tip end portions of the glass refuse movable tube and the glass refuse connection tube, which are connected together when connecting the same, may be disposed at the respective tip end portions of the glass refuse connection tube and glass refuse movable tube, whereby it is possible to prevent processed substances from falling from the connection portions during the transfer. Also, rubber, etc., may be provided as a damping member at the contacting portion of the respective tubes, wherein it is possible to relive an impact generated when being connected.

The vehicle for classifying and collecting refuse according to a ninth aspect of the invention is featured, in addition to the eighth aspect, in that the glass refuse connection tube, the glass refuse movable tube, the classified refuse connection tube and the classified refuse movable tube comprise covering portions disposed at the tip end portion of the glass refuse connection tube and the classified refuse connection tube and/or the glass refuse movable tube and the classified refuse movable tube; a covering portion damping member disposed at a fitting part between the covering portions; a tubular part damping member disposed at a fitting part between the covering portions and the connection tube or the movable tube.

With such a construction, the following actions can be brought about in addition to those obtained by any one of the third aspect through the eighth aspect.

(1) Although the refuse classifying/accommodating portion is inclined to the installation base side after refuse discharge is terminated, and is returned to a state where it is installed, at this time, a cover portion damping member and a tubular portion damping member are disposed at the fitting part between the cover portion and classified refuse connection tube or classified refuse movable tube, and/or at the fitting part between the classified refuse connection tube and the classified refuse movable tube, wherein an impact generated in connecting the classified refuse connection tube and the classified refuse movable tube together can be relieved.

(2) Where the cover portion damping member and tubular portion damping member are formed of a material having high airtightness such as rubber and synthetic resin, it is possible to prevent air from leaking when pneumatic transfer is employed.

The vehicle for classifying and collecting refuse according to a tenth aspect of the invention is featured, in addition to any one of the third aspect through the ninth aspect, in that the non-glass refuse processing apparatus portion comprises: a non-glass refuse crushing portion; a non-glass refuse crushed substance discharging port formed to be roughly funnel-like at the lower part of the non-glass refuse crushing portion; a non-glass refuse supplying portion formed at the upper part of the non-glass refuse crushing portion; a non-glass refuse inputting portion opened at the upper part or side wall of the refuse processing apparatus portion and communicating with the non-glass refuse supplying portion; and a non-glass refuse transferring portion communicating with the non-glass refuse crushed substance discharging port, the discharging port side of which is connected to the classified refuse accommodating port of the classified refuse accommodating portion of the refuse classifying/accommodating portion.

With such a construction, the following actions can be brought about in addition to those obtained by any one of the third aspect through the ninth aspect.

(1) Since the refuse processing apparatus portion is provided with a non-glass refuse processing apparatus portion, non-glass refuse inputted through the refuse inputting portion can be easily and effectively crushed by the non-glass refuse crushing portion capable of crushing the same in response to the characteristics of the non-glass refuse.

Herein, equipment including an impeller for leading processed substances such as cans and plastic bottles to the inner wall of the non-glass refuse crushing portion, a crushing blade disposed at a position enclosing the impeller, and a crushed substance leading portion communicating with the crushed substance discharging portion formed between the inner wall and the crushing blade may be used as the non-glass refuse crushing portion. That is, equipment which sucks and supplies substances to be processed and is able to discharge crushed substances by crushing the same in the non-glass refuse crushing portion and blowing the same may be used. In particular, where an impeller is provided in the non-glass refuse crushing portion, it is possible to suck and supply processed substances such as cans and plastic bottles to the non-glass refuse crushing portion with the centrifugal force of the impeller through an suction portion, and at the same time, the non-glass refuse can be crushed by a crushing blade. Further, the crushed substance can be accommodated in a subsequent refuse classifying/accommodating chamber via the crushed substance leading portion and crushed substance discharging portion.

In addition, a crusher using a shearing force applied by a shredder or a cutter mill may be used. A crusher using a shearing force may be an apparatus in which two entraining rotary teeth having plate-shaped teeth, radially formed on a rotating shaft from its center, disposed in a plurality in parallel to each other with clearance so that the section thereof becomes comb-like in the axial direction, are juxtaposed at the lower part of the non-glass refuse supplying port in the horizontal direction with a prescribed clearance secured, and rotary crushing teeth similar to the entraining rotary teeth are disposed so as to be engaged with each other at the lower part of the respective entraining rotary teeth.

At this time, the entraining rotary teeth are disposed so that non-glass refuse inputted from the non-glass refuse supplying portion drops between the two entraining rotary teeth, and the respective entraining rotary teeth and rotary crushing teeth are caused to rotate in the inward direction so that inputted non-glass refuse is entrained in the teeth. Also, the inputted non-glass refuse is entrained by the entraining rotary teeth and is broken by a shearing force generated by two rotary crushing teeth disposed in engagement with each other at the lower part of the entraining rotary teeth. Thereby, the respective rotary teeth are caused to rotate at a lower speed such as approx. 50 r.p.m. or less, and noise which may be generated by crushing can be reduced.

In addition, since the entraining rotary teeth and rotary crushing teeth are disposed so that one plurality of plate-shaped teeth are placed and nipped in clearance between the other plurality of plate-shaped teeth disposed in parallel to each other, it is possible to prevent crushed substances from being stopped up and accumulated in the clearance of a plurality of plate-shaped teeth disposed in parallel to each other in the axial direction of the entraining rotary teeth and rotary crushing teeth.

The vehicle for classifying and collecting refuse according to an eleventh aspect of the invention is featured, in addition to the tenth aspect, in that the refuse processing apparatus portion comprises a non-glass refuse transferring portion that connects the non-glass refuse inputting portion to the non-glass refuse supplying portion and transfers non-glass refuse inputted by the non-glass refuse inputting portion to the non-glass refuse supplying portion.

With such a construction, the following actions can be brought about in addition to those obtained by the tenth aspect.

(1) Since the refuse processing apparatus portion is provided with a non-glass refuse transferring portion which connects the non-glass refuse inputting portion and the non-glass refuse supplying portion together and transfers non-glass refuse, which is inputted by the non-glass refuse inputting portion, to the non-glass refuse supplying portion, the non-glass refuse inputted in the non-glass refuse inputting portion, which is provided at a low position of the outer wall of the refuse processing apparatus portion, can be easily transferred to the non-glass refuse supplying port, wherein the non-glass refuse can be crushed and compacted as it is. In addition, since the position of the non-glass refuse inputting portion can be made low, a worker is able to easily carry out an input operation.

(2) Since the refuse processing apparatus portion is provided with a non-glass refuse transferring portion which connects the non-glass refuse inputting portion and the non-glass refuse supplying portion together and transfers non-glass refuse, which is inputted by the non-glass refuse inputting portion, to the non-glass refuse supplying portion, non-glass refuse can be inputted into the non-glass refuse inputting portion consecutively and can be subsequently transferred to the non-glass refuse supplying portion, wherein it is possible to attempt to quicken the work.

The non-glass refuse transferring portion may be a conveyor such as a belt conveyor, a bucket conveyor, etc., and a suction apparatus to be used such as a blower, which is provided with a connection tube for connecting the non-glass refuse inputting portion and the non-glass refuse supplying portion, sucks non-glass refuse inputted into the non-glass refuse inputting portion from the non-glass refuse supplying portion side, and transfers the same to the non-glass refuse supplying portion. Also, where a belt conveyor is used as the non-glass refuse transferring portion, it is preferable that a plurality of crosspieces vertically erected with respect to a belt at a prescribed interval in the drive direction of the belt are provided on the surface of the belt of the belt conveyor, wherein even if the belt conveyor is disposed with inclination, it is possible to securely transfer non-glass refuse from the non-glass refuse inputting portion to the non-glass refuse supplying portion. Further, in this case, it is preferable that a chute, etc., is provided at the non-glass refuse inputting portion, and plate rubber, etc., is continuously attached to the inner wall of the chute between the end portion at the outlet side of the chute and the belt conveyor. In this case, if an impeller portion is provided on the surface of the belt, the impeller portion can pass clearance between the belt and the end portion of the chute while being brought into the plate rubber, and since there is no case where non-glass refuse such as cans and plastic bottles drops through the clearance between the belt and the end portion of the chute, it is possible to securely transfer the non-glass refuse.

Also, where a drop-preventing wall formed of rubber, stainless steel, etc., is provided at both sides of the belt conveyor, non-glass refuse can be prevented from dropping from the belt during transfer, wherein a further secure transfer can be brought about.

The vehicle for classifying and collecting refuse according to a twelfth aspect of the invention is featured, in addition to the tenth aspect or the eleventh aspect, in that the non-glass refuse transferring portion comprises a classified refuse connection tube communicating with the non-glass crushed substance discharging port and disposed at the rear side of the refuse processing apparatus portion; a classified refuse movable tube communicating with the non-glass refuse accommodating portion, disposed at the front side of the refuse classifying/accommodating portion, and detachably connected to the classified refuse connection tube.

With such a construction, the following actions can be brought about in addition to those obtained by the tenth aspect or the eleventh aspect.

(1) Non-glass refuse can be effectively crushed, and can be accommodated in the refuse classifying/accommodating portion having a subsequent non-glass refuse accommodating portion etc., via the classified refuse connection tube and classified refuse movable tube detachably connected to the classified refuse connection tube. And, non-glass refuse processed substances can be prevented from becoming bulky in the non-glass refuse accommodating portion. Also, accommodation efficiency can be improved.

(2) Since crushed and compacted non-glass refuse is transferred to respective classified refuse accommodating portions by the classified refuse connection tube and classified refuse movable tube detachably connected to the classified refuse connection tube, the classified refuse movable tube attached to the supplying port of the refuse classifying/accommodating portion is removed from the connection tube and is moved upward together with the refuse classifying/accommodating portion by causing the refuse classifying/accommodating portion to be inclined with respect to the installation base of the vehicle body. Therefore, there is no need to detach the classified refuse connection tube and classified refuse movable tube when discharging crushed substances accommodated in the refuse classifying/accommodating portion, wherein the discharging operation can be easily carried out.

The vehicle for classifying and collecting refuse according to a thirteenth aspect of the invention is featured, in addition to any one of the fourth aspect through the twelfth aspect, in that the classified refuse accommodating portion comprises: an air extractor communicating with the outside of the refuse classifying/accommodating portion, and/or a ventilation portion communicating with classified refuse accommodating portions adjacent to each other.

With such a construction, the following actions can be brought about in addition to those obtained by any one of the fourth aspect through the twelfth aspect.

(1) Since the refuse classifying/accommodating container is provided with an air extractor, air flows can be improved by extracting air in the accommodating container, and processed substances obtained by crushing and compacting cans and plastic bottles can be effectively blown off using wind power, etc., wherein such an action can be brought about, by which processed substances can be transferred from the refuse processing apparatus portion to the refuse classifying/accommodating portion.

(2) Crushed substances, which are pneumatically transferred by the air extractor, can be accommodated without being returned.

Herein, the air extractor may be provided with an air extracting opening portion drilled on the upper wall and/or side wall of the refuse classifying/accommodating portion and its classified refuse accommodating portions, a cylindrical body communicating with the air extracting opening portion, and a net-shaped body covered on the air extracting opening portion and/or cylindrical body end portion. Also, it is preferable that the cylindrical body is formed to be roughly parallel to the wind direction in response to the wind direction, etc., in the refuse classifying/accommodating portion and its classified refuse accommodating portion, wherein it is possible to smoothly extract air in the classified refuse accommodating portion, etc. Also, it is preferable that the net-shaped body has finer meshes than the grain size of processed substances accommodated in the classified refuse accommodating portion, wherein it is possible to prevent the processed substances from being discharged through the air extractor. In particular, where the processed substances accommodated in the classified refuse accommodating portion is fine, a filter may be used instead of the net-shaped body, whereby it is possible to prevent dust from being discharged through the air extractor.

The ventilation portion is formed so as to communicate with another classified refuse accommodating portion adjacent to the side wall of the classified refuse accommodating portion, wherein where no air extractor is formed in the classified refuse accommodating portion, it is possible to extract air in the classified refuse accommodating portion by forming a ventilation portion communicating with the adjacent classified refuse accommodating portion in which the air extractor is formed.

The vehicle for classifying and collecting refuse according to a fourteenth aspect of the invention is featured, in addition to any one of the tenth aspect through the thirteenth aspect, by further including a magnetic classifier connected to the non-glass refuse transferring portion, wherein the refuse classifying/accommodating portion includes a magnetic substance accommodating portion and a non-magnetic substance accommodating portion, into which non-glass refuse processed substances discharged from the non-glass refuse crushing portion are magnetically classified and are respectively inputted.

With such a construction, the following actions can be brought about in addition to those obtained by any one of the tenth aspect through the thirteenth aspect.

(1) Since a magnetic classifier is provided, magnetic substances and non-magnetic substances can be selected from refuse composed of metals while the vehicle for classifying and collecting refuse moves or operates, wherein time can be effectively utilized, and efficiency in refuse processing can be improved.

(2) Since refuse can be classified into, for example, aluminum content and steel content, and these are accommodated in a magnetic substance accommodating portion and a non-magnetic substance accommodating portion, it is possible to increase additional values where the refuse is recycled.

(3) Since the magnetic classifier is provided independently from the non-glass refuse crushing portion and classified refuse accommodating portion, it is possible to easily remove these components when cleaning and repairing, wherein maintenance efficiency thereof is excellent.

Herein, a magnetic classifier, which is provided with, for example, a cyclone portion disposed at the upper part thereof, and a magnet drum portion disposed therebelow, may be used. Air including refuse such as metal scraps sent into the cyclone portion along the circumference thereof is caused to turn inside, and metal scraps are concentrated at the center and are caused to drop. Magnetic constituents in the metal scraps are selectively and magnetically sucked on a rotating magnet drum of the magnet drum portion located at the lower part, wherein magnetic constituents and non-magnetic constituents can be separated from each other.

As described above, according to the vehicle for classifying and collecting refuse of the invention, the following excellent effects can be realized.

According to the vehicle for classifying and collecting refuse as set forth in the first aspect of the invention, the following effects are provided.

(1) Since the vehicle for classifying and collecting refuse is provided with a refuse processing apparatus portion and a refuse classifying/accommodating portion, the vehicle is able to move to a collecting refuse place, classify and collect various kinds of refuse such as glass refuse, cans and plastic bottles at the place, and transfer the refuse to a refuse processing facility while carrying out a classified refuse compacting process. Therefore, crushing and classifying of refuse can be achieved at a time, wherein work efficiency its excellent.

(2) Since the refuse classifying/accommodating portion is installed at the installation base of the vehicle body equipped with an attaching and detaching apparatus so as to freely incline, if the refuse classifying/accommodating portion is inclined with respect to the installation base of the vehicle body after various kinds of refuse compacted and processed by the refuse processing apparatus portion are filled in the refuse classifying/accommodating portion, refuse in the refuse classifying/accommodating portion can be easily discharged through the refuse discharging port disposed at the rear part side, wherein operation efficiency is excellent.

(3) Since the refuse classifying/accommodating portion is installed at the installation base, the distance between the refuse processing apparatus portion and the refuse classifying/accommodating portion can be shortened. After refuse is crushed and classified, processed substances can be easily transferred from the refuse processing apparatus portion to the refuse classifying/accommodating portion, and at the same time, a transfer apparatus required to transfer the processed substances can be made small-sized, wherein energy can be saved.

(4) Since the refuse classifying/accommodating portion is completely separated from the refuse processing apparatus portion, respective classified refuse accommodating portions with a simple structure can be formed without any drive portion, etc., at the refuse classifying/accommodating portion, the refuse classifying/accommodating portion can be removed from the vehicle body in a processing facility, and the processed substances can be easily discharged, wherein subsequent processing can be efficiently carried out.

According to the vehicle for classifying and collecting refuse as set forth in the second aspect of the invention, the following effects can be provided in addition to those obtained by the first aspect.

(1) Since the refuse inputting portion of the refuse processing apparatus portion is formed at the left side of a vehicle body in the case where the vehicle body is for a left-hand side traffic system or at the right side thereof in the case where the vehicle body is for a right-hand side traffic system, the vehicle is able to quickly and safely collect various kinds of refuse placed on a road side. In particular, where the refuse inputting portion is located at the same side as that of the front passenger seat of the above-described vehicle for classifying and collecting refuse, a worker seated in the front passenger seat quickly gets off and is able to carry out collection work, wherein work efficiency can be improved.

(2) Since the refuse inputting portion is provided only at one side of the vehicle body sides, the refuse processing apparatus portion installed at the installation base can be widened, and a wide space of the refuse processing apparatus portion can be secured, wherein convenience can be further improved.

According to the vehicle for classifying and collecting refuse as set forth in the third aspect of the invention, the following effects can be provided in addition to those obtained by the first or second aspect.

(1) Since the refuse processing apparatus portion is provided with a glass refuse processing apparatus for crushing or compacting glass refuse and a non-glass refuse processing apparatus portion for crushing or compacting metals such as empty cans or plastics such as plastic bottles, it is possible to classify, and crush or compact glass refuse and non-glass refuse, excellent convenience can be secured, and no manual classifying work is required, wherein since no additional worker nor work processes are required, processing costs can be decreased.

According to the vehicle for classifying and collecting refuse as set forth in the fourth aspect of the invention, the following effects can be provided in addition to those obtained by any one of the first aspect through the third aspect.

(1) Since the refuse classifying/accommodating portion is sectioned by the glass refuse accommodating portion and one or more classified refuse accommodating portions and these portions are connected to the refuse processing apparatus portion via a detachable connection tube, the classified refuse accommodating portions are changed in response to the fitting relation with the discharging port secured at the refuse processing apparatus portion side and the accommodation quantity of the classified refuse accommodating portions, and the refuse can be efficiently crushed and classified.

(2) Since the glass refuse accommodating portion is disposed rearward of the refuse processing apparatus portion, adjacent thereto, the distance between both the glass refuse accommodating portion and the refuse processing apparatus portion can be shortened, wherein the transferring apparatus for transferring processed substances to the glass refuse accommodating portion can be made small-sized.

(3) Where a glass refuse accommodating port is provided in the upper wall of the glass refuse accommodating portion, glass refuse processed substances having comparatively heavy specific gravity are easily and uniformly inputted therethrough to prevent the processed substances from being partially concentrated, wherein the accommodation efficiency of the glass refuse accommodating portion can be increased.

(4) Where the classified refuse accommodating portion is disposed with its lengthwise direction parallel to the advancement direction of the vehicle, no dead space is formed when pneumatically discharging processed substances to the above-described refuse classifying/accommodating portion, and crushed scraps of cans, plastic bottles, etc., can be efficiently classified and accommodated.

According to the vehicle for classifying and collecting refuse as set forth in the fifth aspect of the invention, the following effects can be provided in addition to those obtained by any one of the first aspect through the fourth aspect.

(1) Since the refuse classifying/accommodating portion is provided with a glass refuse accommodating portion and/or one or more classified refuse accommodating portions, which are sectioned and formed in parallel with the width direction of the vehicle body, if the supplying port at the front side of respective accommodating portions and further the discharging port at the rear side thereof are disposed, the apparatus for transferring from the refuse processing apparatus portion to the refuse classifying/accommodating portion can be made small-sized.

(2) Since the respective accommodating portions are sectioned to be parallel with the width direction of the vehicle body, and is formed from the front side to the rear side of the vehicle body at the lengthwise direction, for inclining the refuse classifying/accommodating portion the rear side of the vehicle body by the inclination apparatus portion, accommodated refuse can be prevented by being caught in the interior of the accommodating portions, wherein work efficiency can be improved.

According to the refuse classifying and collecting vehicle as described in the sixth aspect of the invention, the following effects can be provided in addition to those obtained by any one of the third aspect through the fifth aspect.

(1) Since the refuse processing apparatus portion is provided with a glass refuse processing apparatus, glass refuse inputted via the refuse inputting portion can be easily and effectively crushed by the glass refuse crushing portion that is able to crush glass refuse in response to the characteristics thereof.

(2) Since the refuse processing apparatus portion is provided with a transferring apparatus having a belt conveyor and a spiral mechanism, which are able to transfer crushed glass refuse where the transferring apparatus is composed of a metallic pipe and a screw conveyor inserted into the pipe, processed glass refuse can be efficiently transferred to the refuse classifying/accommodating portion placed rearward.

(3) By forming the crushed substance discharging side of the glass refuse crushing portion to be funnel-like, glass refuse substances crushed and processed by the glass refuse crushing portion can be prevented from being accumulated in the crushed substance discharging port, and can be smoothly supplied to the transferring apparatus and refuse classifying/accommodating portion.

According to the refuse classifying and collecting vehicle as described in the seventh aspect of the invention, the following effects can be brought about in addition to those obtained by the sixth aspect.

(1) Since a bucket conveyor for elevating and lowering buckets is disposed at outer wall side of the refuse processing apparatus portion, glass refuse is inputted into a bucket when it is positioned at the lower part of the outer wall of the refuse processing apparatus portion, wherein it becomes possible to easily and safely transfer a large amount of glass refuse by actuating the bucket conveyor, and work efficiency and safety are excellent.

(2) Since the buckets can be moved with glass refuse held, glass refuse is not broken and scattered during the transfer, wherein collection work of refuse including glass refuse can be securely carried out, and safety is excellent.

According to the vehicle for classifying and collecting refuse as set forth in the eighth aspect of the invention, the following effects can be provided in addition to those obtained by the sixth aspect or the seventh aspect.

(1) Since crushed and compacted glass refuse is transferred to the glass refuse accommodating portion by a glass refuse connection tube and a glass refuse movable tube detachably connected to the glass refuse connection tube, the glass refuse movable tube attached to the supplying port of the refuse classifying/accommodating portion is separated from the glass refuse connection tube and moves upward together with the refuse classifying/accommodating portion by causing the refuse classifying/accommodating portion to be inclined with respect to the installation base of the vehicle body. Therefore, there is no need to detach the tubes when discharging crushed substances accommodated in the refuse classifying/accommodating portion, wherein it is easy to carry out discharging work.

According to the vehicle for classifying and collecting refuse as set forth in the ninth aspect of the invention the following-effects can be provided in addition to those obtained by the eighth aspect.

(1) Refuse discharge is terminated, the refuse classifying/accommodating portion is inclined to the installation base side, and is returned to its installed state on the installation base. However, at this time, if a cover portion damping member and tubular portion damping member are disposed at the fitting portions between the cover portion and classified refuse connection tube or classified refuse movable tube, and/or fitting portions between the classified refuse connection tube and the classified refuse movable tube, an impact can be relieved, which is generated when connecting the classified refuse connection tube and classified refuse movable tube together.

(2) Where the cover portion damping member and tubular portion damping member are formed of a material having high airtightness such as rubber and synthetic resin, it is possible to prevent air from leaking when pneumatic transfer is employed.

According to the vehicle for classifying and collecting refuse as set forth in the tenth aspect of the invention, the following effects can be provided in addition to those obtained by any one of the third aspect through ninth aspect.

(1) Since the refuse processing apparatus portion is provided with a non-glass refuse processing apparatus portion, non-glass refuse inputted through the refuse inputting portion can be easily and effectively crushed by the non-glass refuse crushing portion capable of crushing the same in response to the characteristics of the non-glass refuse.

According to the vehicle for classifying and collecting refuse as set forth in the eleventh aspect of the invention, the following effects can be provided in addition to those obtained by the tenth aspect.

(1) Since the refuse processing apparatus portion is provided with a belt conveyor which connects the non-glass refuse inputting portion and the non-glass refuse supplying together and transfers non-glass refuse, which is inputted by the non-glass refuse inputting portion, to the non-glass refuse supplying portion, the non-glass refuse inputted in the non-glass refuse inputting portion, which is provided on the outer wall of the refuse processing apparatus portion, can be easily transferred to the non-glass refuse supplying port, wherein the non-glass refuse can be crushed and compacted as it is. Therefore, the work processes are decreased and excellent operation efficiency can be brought about.

(2) Since the refuse processing apparatus portion is provided with a belt conveyor which connects the non-glass refuse inputting portion and the non-glass refuse supplying portion together and transfers non-glass refuse, which is inputted by the non-glass refuse inputting portion, to the non-glass refuse supplying portion, non-glass refuse can be inputted into the non-glass refuse inputting portion consecutively and can be subsequently transferred to the non-glass refuse supplying portion, wherein it is possible to attempt to quicken the work.

According to the vehicle for classifying and collecting refuse as set forth in the twelfth aspect of the invention, the following effects can be provided in addition to those obtained by the tenth aspect or the eleventh aspect.

(1) Non-glass refuse can be effectively crushed, and can be accommodated in the refuse classifying/accommodating portion having a subsequent non-glass refuse accommodating portion etc., via the classified refuse connection tube and classified refuse movable tube detachably connected to the classified refuse connection tube. And, non-glass refuse processed substances can be prevented from becoming bulky in the non-glass refuse accommodating portion. Also, accommodation efficiency can be improved.

(2) Since crushed and compacted non-glass refuse is transferred to respective classified refuse accommodating portions by the classified refuse connection tube and classified refuse movable tube detachably connected to the classified refuse connection tube, the classified refuse movable tube attached to the supplying port of the refuse classifying/accommodating portion is removed from the connection tube and is moved upward together with the refuse classifying/accommodating portion by causing the refuse classifying/accommodating portion to be inclined with respect to the installation base of the vehicle body. Therefore, there is no need to detach the classified refuse connection tube and classified refuse movable tube when discharging crushed substances accommodated in the refuse classifying/accommodating portion, wherein the discharging operation can be easily carried out.

According to the vehicle for classifying and collecting refuse as set forth in the thirteenth aspect of the invention, the following effects can be provided in addition to those obtained by any one of the fourth aspect through the twelfth aspect.

(1) Since the refuse classifying/accommodating container is provided with an air extractor, air flows can be improved by extracting air in the accommodating container, and processed substances obtained by crushing and compacting cans and plastic bottles can be effectively blown off using wind force, etc., wherein processed substances can be transferred from the refuse processing apparatus portion to the refuse classifying/accommodating portion.

According to the vehicle for classifying and collecting refuse as set forth in the fourteenth aspect of the invention, the following effects can be provided in addition to those obtained by any one of the tenth aspect through the thirteenth aspect.

(1) Since a magnetic classifier is provided, magnetic substances and non-magnetic substances can be selected from refuse composed of metals while the vehicle for classifying and collecting refuse moves or operates, wherein time can be effectively utilized, and efficiency of refuse processing can be improved.

(2) Since refuse can be classified into, for example, aluminum content and steel content, and these are accommodated in a magnetic substance accommodating portion and a non-magnetic substance accommodating portion, it is possible to increase additional values where the refuse is recycled.

(3) Since the magnetic classifier is provided independently from the non-glass refuse crushing portion and classified refuse accommodating portion, it is possible to easily remove these components when cleaning and repairing, wherein maintenance efficiency thereof is excellent.

### DESCRIPTION OF THE DRAWINGS

FIG. 1 is a side view showing the major parts of a vehicle for classifying and collecting refuse according to Embodiment 1;

FIG. 2 is a sectional view showing the major parts of a refuse processing apparatus portion of the vehicle for classifying and collecting refuse according to Embodiment 1;

FIG. 3 is a sectional view showing the major parts, which is taken along the line A-A in FIG. 2, according to Embodiment 1;

FIG. 4 is a sectional view showing the major parts of a non-glass refuse crushing portion;

FIG. 5 is a sectional view showing the major parts, which is taken along the line B-B in FIG. 4, according to Embodiment 1;

FIG. 6 is a plan view showing the major parts of the refuse classifying/accommodating portion according to Embodiment 1;

FIG. 7 is a rear side view showing the major parts of the refuse classifying and accommodating portion according to Embodiment 1;

FIG. 8 is a side view of the major parts, showing an inclined state of the refuse classifying/accommodating portion according to Embodiment 1;

FIG. 9(a) is a side view of the major parts, showing glass refuse and classified refuse connection tubes and glass refuse and classified refuse movable tubes of the refuse classifying/collecting vehicle according to Embodiment 1;

FIG. 9(b) is a front view of the major parts, showing glass refuse and classified refuse movable tubes of the vehicle for classifying and collecting refuse according to Embodiment 1;

FIG. 9(c) is a front view of the major parts, showing glass refuse and classified refuse connection tubes of the vehicle for classifying and collecting refuse according to Embodiment 1;

FIG. 10 is a front sectional view showing the inner structure of the magnetic classifier; and

FIG. 11 is a side sectional view of the magnetic classifier.

### DESCRIPTION OF THE PREFERRED EMBODIMENTS

Hereinafter, a detailed description is given of an embodiment of the present invention. Also, as a matter of course, the present invention is not limited to the following embodiment.

(Embodiment 1)

A description is given below of a vehicle for classifying and collecting refuse according to Embodiment 1 of the invention with reference to the drawings.

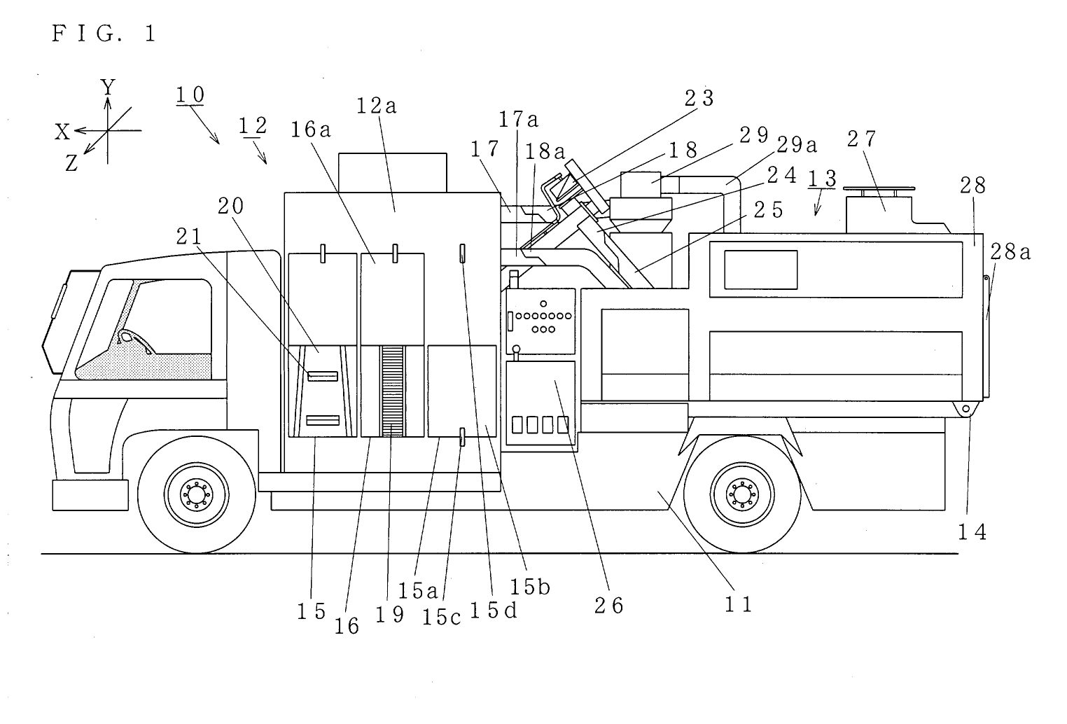

FIG. 1 is a side view showing the major parts of a vehicle for classifying and collecting refuse according to Embodiment 1.

In FIG. 1, reference number 10 denotes a vehicle for classifying and collecting refuse according to Embodiment 1, an installation base 11 is disposed rearward of the vehicle body of the vehicle for classifying and collecting refuse 10. A refuse processing apparatus portion 12 is installed at the rear side of the driver's seat. 12a is a side wall of the refuse processing apparatus portion 12, a refuse classifying/accommodating portion 13 is inclinably installed at the installation base 11 rearward of the refuse processing apparatus portion 12 by an inclination apparatus portion described later, and a fulcrum portion 14 becomes a fulcrum point when the rear end portion at the bottom side of the refuse classifying/accommodating portion 13 is axially attached to the installation base 11 and the refuse classifying/accommodating portion 13 is inclined. A non-glass refuse inputting portion 15 for cans constitutes the refuse inputting portion and inputs refuse such as non-glass refuse such as empty cans into the refuse processing apparatus portion 12. A non-glass refuse inputting portion 15a for plastic bottles constitutes the refuse inputting portion and inputs-refuse such as non-glass refuse such as plastic bottles into the refuse processing apparatus portion 12. An opening and closing door 15b is disposed at the non-glass refuse inputting portion 15, an engagement portion 15c is formed at the opening and closing door 15b, and an engaged portion 15d is formed on the side wall 12a, in which the engagement portion 15c is engaged when the opening and closing door 15b is open. A glass refuse inputting portion 16 constitutes the refuse inputting portion and inputs refuse such as glass refuse into the refuse processing apparatus portion 12, and an opening and closing door 16a is disposed at the glass refuse inputting portion 16. A classified refuse connection tube 17 for cans supplies non-glass processed substances such as cans, processed by the refuse processing apparatus portion 12, into the refuse classifying/accommodating portion 13, and a classified refuse connection tube 17a for plastic bottles supplies non-glass processed substances such as plastic bottles, processed by the refuse processing apparatus portion 12, into the refuse classifying/accommodating portion 13. A classified refuse movable tube 18 for cans is detachably connected to the classified refuse connection tube 17 for cans, and is connected to a magnetic classifier, described later, that is disposed at the front part of the refuse classifying/accommodating portion 13, and a classified refuse movable tube 18a for plastic bottles is detachably connected to the classified refuse connection tube 17a for plastic bottles, and is connected to the front part of the refuse classifying/accommodating portion 13. A bucket conveyor 19 elevates and lowers bucket 39 described later by means of a belt and a chain. A belt conveyor 20 connects the non-glass refuse inputting portion 15 and a non-glass refuse supplying portion described later to each other and transfers non-glass refuse. A crosspiece portion 21 is disposed on the belt of the belt conveyor 20 with prescribed intervals secured. A transfer driving portion 23 rotates a screw (not illustrated) that transfers glass refuse crushed and processed by the refuse processing apparatus portion 12. A glass refuse connection tube 24 supplies processed substances such as glass refuse, which are processed by the refuse processing apparatus portion 12, into the refuse classifying/accommodating portion 13. A glass refuse movable tube 25 is disposed at the front part of the refuse classifying/accommodating portion 13 connected to the glass refuse connection tube 24. An inclination apparatus operating portion 26 operates the inclination apparatus portion in order to cause the refuse classifying/accommodating portion 13 to be inclined. An air extractor 27 is provided at the upper part of the refuse classifying/accommodating portion 13. A group of opening and closing doors 28a for discharge is disposed so as to freely turn at the rear part wall 28 at the upper part of the refuse discharging opening portion at the rear part of the refuse classifying/accommodating portion 13. A magnetic classifier 29 classifies non-glass refuse into magnetic constituents and non-magnetic constituents. An air exhaust portion 29a exhausts air when pneumatically conveying non-glass refuse to the magnetic classifier 29.

Also, in FIG. 1, X denotes the forward and backward direction of the vehicle for classifying and collecting refuse 10, Y denotes the vertical direction of the vehicle for classifying and collecting refuse 10. Z denotes the width direction of the vehicle for classifying and collecting refuse 10. This is applicable to the following drawings.

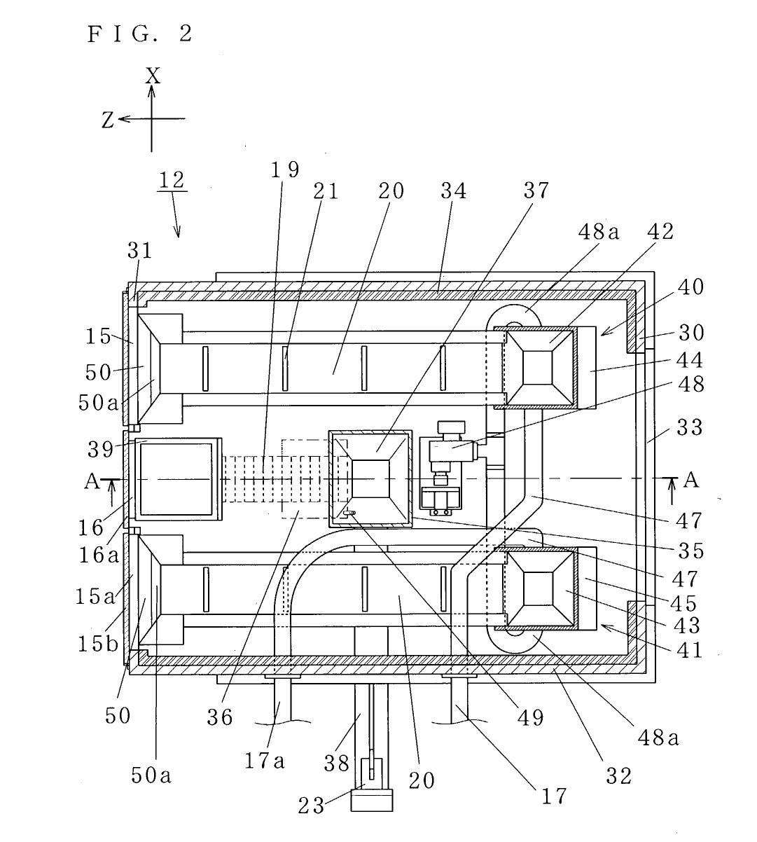

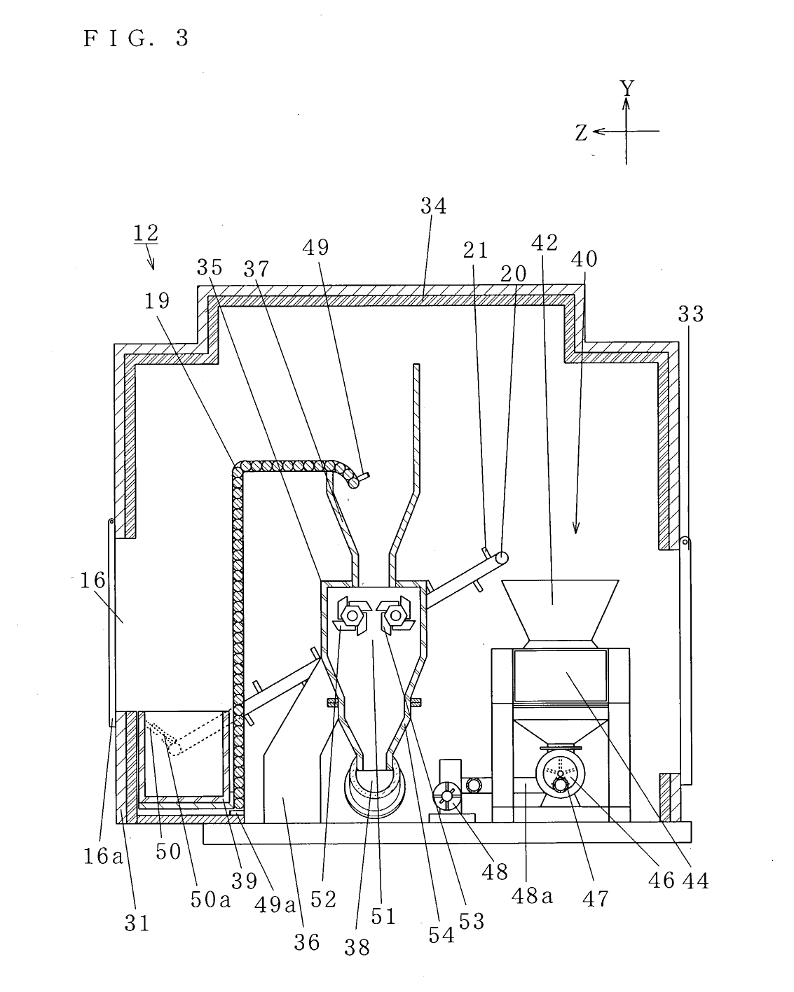

FIG. 2 is a sectional plan view showing the major parts of a refuse processing apparatus portion that is disposed on the vehicle for classifying and collecting refuse according to Embodiment 1, and FIG. 3 is a sectional view showing the major parts, which is taken along the line A-A in FIG. 2.

In the drawings, reference number 30 denotes a housing of the refuse processing apparatus portion 12; and 31 denotes an input side wall of the housing 30. A discharging side wall 32 of the housing 30 is orthogonal to the input side-wall 31. An inspection door portion 33 is openably formed at a prescribed portion of the side part and upper part of the housing 30. A soundproof member 34 is disposed on the inner circumferential surface of the housing 30. A two-axis type glass refuse crushing portion 35 of the glass refuse processing apparatus is disposed at roughly the central portion of the refuse processing apparatus portion 12. A glass refuse crushing drive portion 36 of the glass refuse crushing portion 35 is disposed at the input side wall 31 side of the glass refuse crushing portion 35. A glass refuse supplying portion 37 of the glass refuse processing apparatus is disposed at the upper part of the glass refuse crushing portion 35. A glass refuse transferring portion 38 transfers glass refuse, one end of which is connected to the lower part of the glass refuse crushing portion 35 and is passed through the discharging side wall 32 of the housing 30, and the other end of which is connected to the glass refuse movable tube 25 and has a screw conveyor therein. A bucket 39 in which glass refuse is inputted is disposed at the outer wall side of the refuse processing apparatus portion 12 which constitutes the refuse inputting portion. A non-glass refuse crushing and processing apparatus 40 for cans such as steel cans and aluminum cans is disposed in the refuse processing-apparatus portion 12. A non-glass refuse crushing and processing apparatus 41 for plastic bottles is disposed in the refuse processing apparatus portion 12. A non-glass refuse supplying portion 42 transfers and supplies non-glass refuse such as empty cans, which are inputted through the non-glass refuse inputting portion 16, by means of the belt conveyor 20. A non-glass refuse supplying portion 43 transfers and supplies non-glass refuse such as plastic bottles, which are inputted through the non-glass refuse inputting portion 15, by means of the belt conveyor 20. A non-glass refuse crushing portion 44 for cans of the non-glass refuse processing apparatus portion is disposed in the refuse processing apparatus portion 12. A non-glass refuse crushing portion 45 for plastic bottles of the non-glass refuse processing apparatus portion is disposed in the refuse processing apparatus portion 12. A transfer amount controlling portion 46 consists of rotary valves disposed at the respective lower parts of the non-glass refuse crushing portions 44 and 45. A metal-made or hard rubber-made duct-shaped crushed substance discharging tube 47 having flexibility is disposed so that one end thereof is connected to the respective non-glass refuse crushing portions 44 and 45, and the other end thereof is passed through the discharging side wall 32 of the housing 30 toward the refuse classifying/accommodating portion 13 side. An air discharging portion 48 such as a blower, etc., discharges air to the transfer amount controlling portion 46 in order to pneumatically transfer the crushed substances, which are divided into small parts by the transfer amount controlling portion 46, to the refuse classifying/accommodating portion 13. An air exhausting tube 48a connects the air discharging portion 48 and the transfer amount controlling portion 46 to each other. Detecting means 49 and 49a consisting of proximity switches are disposed at the upper and lower parts of the bucket conveyor 19 and detect arrival of the bucket 39 at the glass refuse inputting portion 37. A chute portion 50 is disposed at the non-glass refuse inputting portion 15 and causes the inputted non-glass refuse to fall on the belt of the belt conveyor 20. A rubber-like portion 50a is disposed at the tip end portion of the chute portion 50 and is formed of rubber and synthetic resin, etc., to permit the crosspiece portion 21 to pass through when the belt conveyor 20 is driven. Reference number 51 denotes a crushing and processing-portion of the glass refuse crushing portion 35. A pair of comb-shaped glass refuse crushing teeth 52 and 53 are rotatably disposed in the crushing and processing portion 51. A crushed substance discharging port 54 is formed to be funnel-like downward of the crushing and processing portion 51.

Also, the inclination angle of the inclined plane of the crushed substance discharging port 54 (Refer to FIG. 3) formed funnel-like is established to be approximately. 45° through 60° from the installation plane of the glass refuse crushing portion 35, wherein glass refuse crushed substances crushed by the crushing and processing portion 51 can be naturally transferred to the glass refuse transferring portion 38 without increasing the height of the glass refuse crushing portion 35.

In addition, the glass refuse transferring portion 38 (Refer to FIG. 3) consisting of a screw conveyor is disposed with an inclination angle of approximately. 15° through 45° from the installation plane of the glass refuse transferring portion 38. If the inclination angle of the glass refuse transferring portion 38 is decreased below 15°, the transferring distance of the glass refuse crushed substances is lengthened when transferring the glass refuse crushed substances up to a prescribed height, and the above-described refuse processing apparatus portion is accordingly liable to become large in size, and if the inclination angle is increased above 45°, glass refuse crushed substances are likely to drop downward when transferring the glass refuse crushed substances, wherein a transfer loss is generated. Neither of these is preferable

Further, a magnetic proximity sensor is used as detecting means 49 and 49a (Refer to FIG. 2 and FIG. 3 for detecting the position of the bucket 39. At least the part of the bucket 39 facing the detecting means 49 and 49a is of a steel-made magnetic body, whereby the detecting means 49 and 49a detect magnetism of the bucket 39 and can securely detect arrival of the bucket 19, and simultaneously, since the magnetic proximity sensor has an environment resisting property, the detecting means 49 and 49a malfunction less, wherein durability thereof can be improved. Further, a limit switch that is able to mechanically detect the position of the bucket 39 may be used instead of the magnetic proximity sensor.

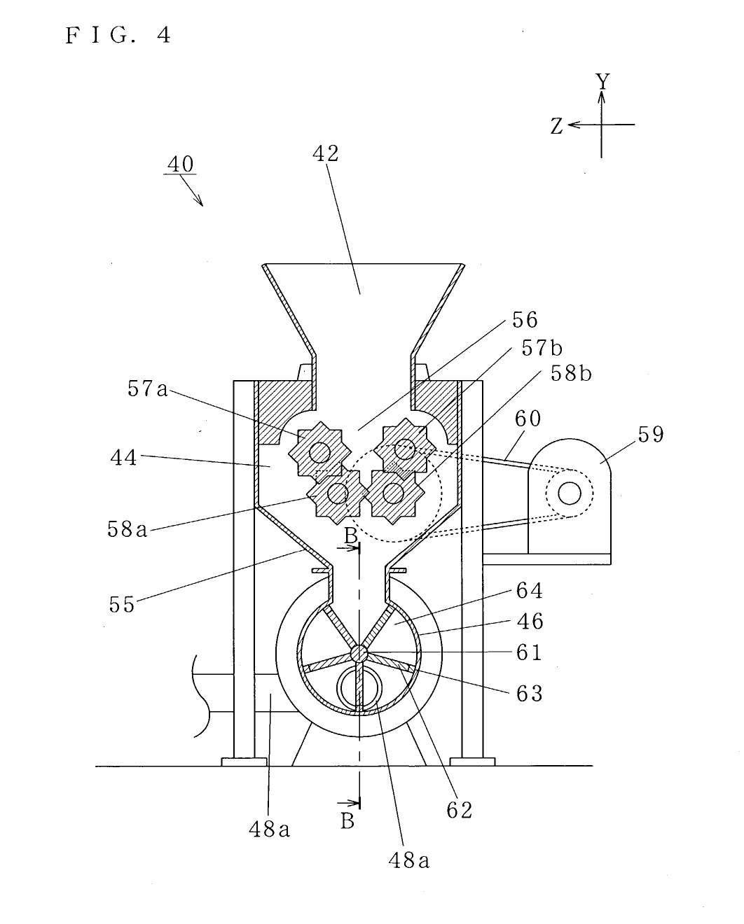

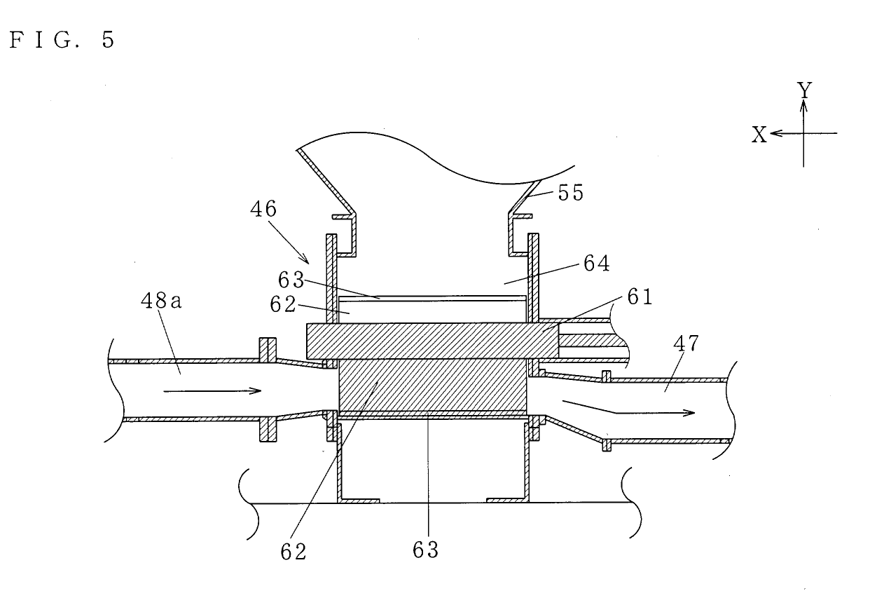

FIG. 4 is a sectional view showing the major parts of a non-glass refuse processing apparatus portion disposed on a vehicle for classifying and collecting refuse according to Embodiment 1, and FIG. 5 is a sectional view showing the major parts, which is taken along the line B-B in FIG. 4.

In the drawings, a non-glass refuse crushed substance discharging port 55 is formed funnel-like at the lower part of the non-glass refuse crushing portion 44. Reference number 56 denotes a non-glass refuse crushing and processing portion of the non-glass refuse crushing portion 44. Entraining rotary teeth 57a and 57b are formed like a comb in the axial direction on a rotary shaft and are juxtaposed in the horizontal direction at the lower part of the non-glass refuse supplying port with a prescribed interval secured. Rotary crushing teeth 58a and 58b are disposed so as to be engaged with each other at the respective lower parts of the entraining rotary teeth 57a and 57b. A rotary teeth driving portion 59 rotates the rotary crushing teeth 58b and rotates other respective rotary teeth interlocking therewith. A drive belt 60 transmits rotations of the rotary teeth driving portion 59 to a roller (not illustrated) that coaxially rotates integrally with the rotary crushing teeth 58b. A rotary shaft portion 61 is disposed inside the transfer amount controlling portion 46. A rotary wall portion 62 is erect around the rotary shaft portion 61. An inner wall fitting portion 63 is disposed along one end portion of the rotary wall portion 62 and rotates along with the rotary wall portion 62 while being in contact with the inner wall of the transfer amount controlling portion 46. A metering portion 64 is formed of two rotary wall portions adjacent to each other.

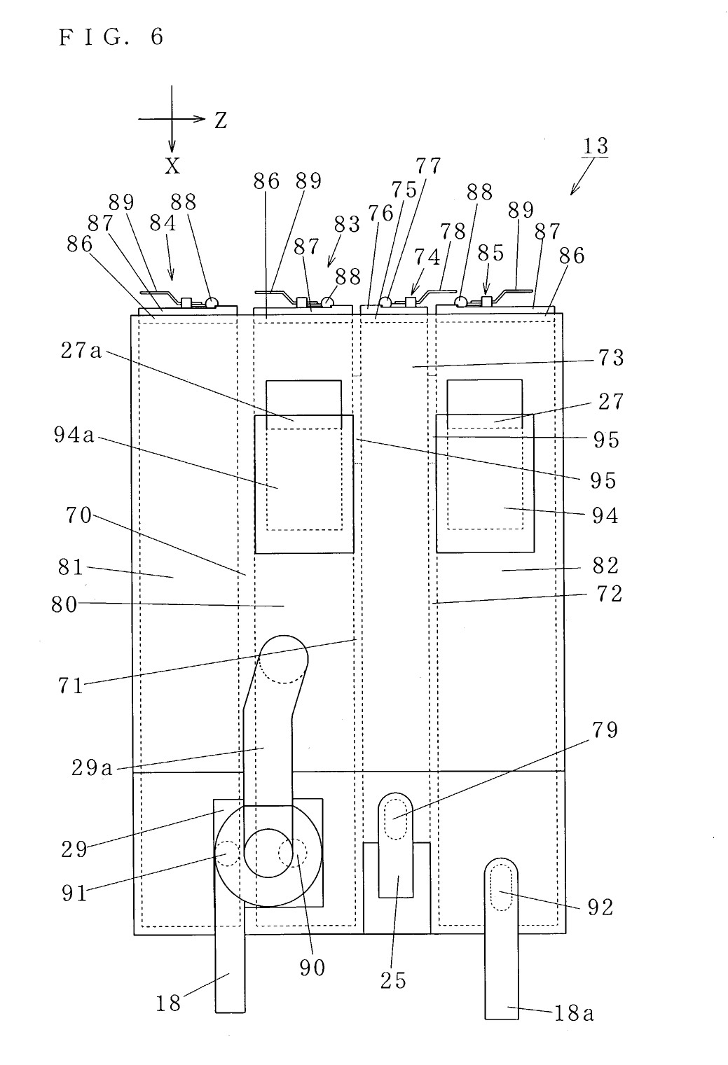

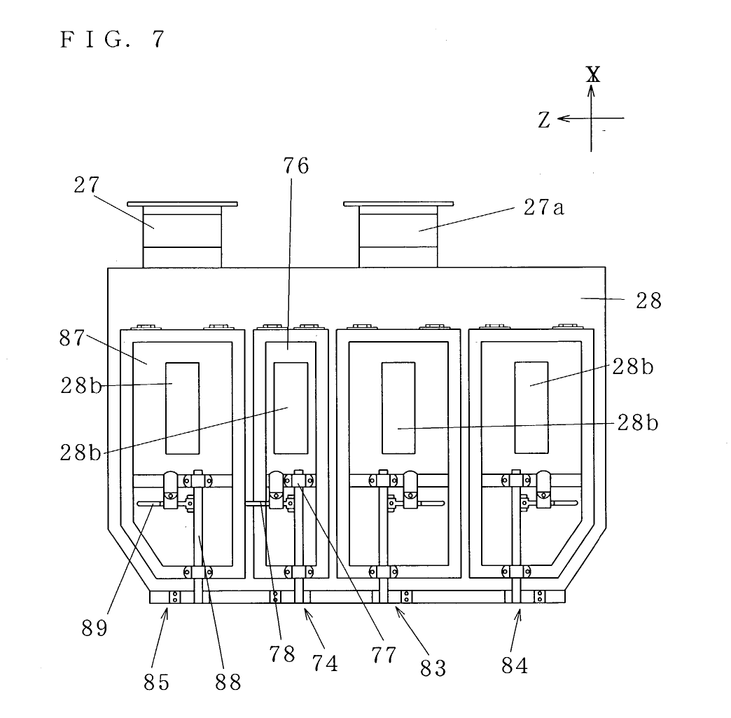

FIG. 6 is a plan view showing the major parts of the refuse classifying/accommodating portion 13. FIG. 7 is a rear side view showing the major parts of the refuse classifying/accommodating portion 13.

In the drawings, sectioning walls 70, 71 and 72 section the inside of the refuse classifying/accommodating portion in parallel with the vehicle width direction. A glass refuse accommodating portion 73 is sectioned by the sectioning walls 71 and 72 and is formed so that its lengthwise direction is made parallel with the forward and rearward direction of the vehicle body. A glass refuse discharging port 74 is formed at the side wall at the rear part side of the glass refuse accommodating portion 73. An opening portion 75 of the glass refuse discharging port 74 is formed on the side wall at the rear part side of the glass refuse accommodating portion 73. An opening and closing door 76 of the glass refuse discharging port 74 is openably disposed at the rear part wall 28 at the upper part of the opening portion 75. A fastening portion 77 fastens the opening and closing door 76. Reference number 78 denotes a grip of the fastening portion 77. A glass refuse accommodating port 79 is formed at the front-part side of the glass refuse accommodating portion 73, to which the glass refuse movable tube 25 is connected. Aluminum can accommodating portion (classified refuse accommodating portion) 80 is sectioned by the sectioning walls 70 and 71 and is formed so that its lengthwise direction becomes parallel with the forward and rearward direction of the vehicle body. A steel can accommodating portion (classified refuse accommodating portion) 81 is sectioned by the sectioning wall 70 and outer wall, and is, formed so that its lengthwise direction is made parallel with the forward and rearward direction of the vehicle body. A plastic bottle accommodating portion (classified refuse accommodating portion) 82 is sectioned by the sectioning wall 72 and outer wall and is formed so that its lengthwise direction is made parallel with the forward and rearward direction of the vehicle body. Respective classified refuse discharging ports 83, 84 and 85 for aluminum cans, steel cans, and plastic bottles are formed at the rear side wall (the rear side wall of the refuse classifying/accommodating portion 13) of the respective accommodating portions 80, 81 and 82. Reference number 87 denotes an opening and closing door of the classified refused is charging ports 83, 84 and 85. A fastening portion 88 fastens the opening and closing door 87. Reference number 89 denotes a grip of the fastening portion 88. An aluminum can accommodating port 90 (classified refuse accommodating port), to which magnetically classified aluminum crushed substances are supplied, is formed at the front side wall of the aluminum can accommodating portion 80 and at the lower part of the magnetic classifier 29 disposed at the front side of the refuse classifying/accommodating portion 13. A steel can accommodating port 91 (classified refuse accommodating port), to which magnetically classified steel crushed substances are supplied, is formed at the front side wall of the steel can accommodating portion 81 and at the lower part of the magnetic classifier 29 disposed at the front part side of the refuse classifying/accommodating portion 13. A plastic bottle accommodating port (classified refuse accommodating port) 92 is formed at the front side wall of the plastic bottle accommodating portion 82 and is connected to the classified refuse movable tube disposed at the front part side of the refuse classifying/accommodating portion 13. Air extracting opening portions 94 and 94a are formed at the upper part wall of the classified refuse accommodating portions 82 and 80 and cause the classified refuse accommodating portions 82 and 80 and air extractors 27 and 27a to communicate with each other. A ventilation portion 95 is formed so as to open on the respective side walls of the sectioning walls 71 and 72 and causes the aluminum can accommodating portion 80 to communicate with the plastic bottle accommodating portion 82. Also, a window portion 28b is formed in the respective opening and closing doors 76 and 87.

In addition, instead of forming the glass refuse accommodating portion 73, aluminum can accommodating portion 79, steel can accommodating portion 80 and plastic bottle accommodating portion 81 by sectioning the inside of the refuse classifying/accommodating portion 13 by the sectioning walls 70, 71 and 72, containers, which are, respectively, composed of independent components, may be coupled together to construct the refuse classifying/accommodating portion 13.

Further, in FIG. 7, although the opening and closing door 87 is provided at the rear part side of the refuse classifying/accommodating portion 13 in order to discharge accommodated refuse while inclining the refuse classifying/accommodating portion 13 rearward of the vehicle body by the inclination apparatus portion, the opening and closing door may be provided sideward of the refuse classifying/accommodating portion 13 and the accommodated refuse may be discharged by inclining the refuse classifying/accommodating portion 13 sideward of the vehicle body by the inclination apparatus portion.

Next, a description is given below of actions of a glass refuse processing apparatus of the refuse processing apparatus portion in a vehicle for classifying and collecting refuse 10 according to Embodiment 1 with reference to the drawings.

As shown in FIG. 1 through FIG. 3, where glass refuse is crushed and processed, glass refuse is inputted in the bucket 39, which is disposed inside the refuse processing apparatus portion 12 of the vehicle for classifying-and-collecting refuse 10 in an idle state, through the glass refuse inputting portion 16, and the bucket conveyor 19 is driven by pressing the hand button switch fixed at the side wall. The bucket 39 is elevated by the bucket conveyor 19, and is turned and inclined at termination. Then, glass refuse is inputted into the glass refuse supplying portion 37. After the bucket 39 stops at the position until it becomes empty (approx. 5 seconds to ten seconds), the bucket automatically drops, and arrival of the bucket 39 is detected by the detecting means 49a disposed at the lower part of the bucket conveyor 19. Then, the bucket 39 stops at its lower end.

As shown in FIG. 1 through FIG. 3, the glass refuse crushing drive portion 36 of the glass refuse crushing portion 35 and the transfer drive portion 23 of the glass refuse transferring portion 38 commence to drive when the arrival of the bucket 39 is detected by the detecting means 49 disposed at the upper end of the bucket conveyor 19.

Glass refuse inputted in the glass refuse supplying portion 37 is supplied into the crushing and processing portion 51 of the glass refuse crushing portion 35 via a communications port that forms the glass refuse supplying portion 37, and is crushed and processed by the glass refuse crushing teeth 52 and 53 of the crushing and processing portion 51.

Glass refuse crushed substances, which are crushed and processed, are discharged through the crushed substance discharging port 54 and supplied into the glass refuse transferring portion 38 via an inputting port of the glass refuse transferring portion 38. In the glass refuse transferring portion 38 consisting of a screw conveyor, glass refuse crushed substances are transferred by a screw of the glass refuse transferring portion 38 and discharged to the glass refuse accommodating portion 73 through the glass refuse connection tube 24 and glass refuse movable tube 25 of the vehicle for classifying and collecting refuse 13.

Also, although it is controlled that the glass refuse crushing portion 35 and glass refuse transferring portion 38 are driven for the first time when arrival of the bucket 39 is detected by the detecting means 49 at the upper part of the bucket conveyor 19, the portions 35 and 38 may be driven by pressing a hand operation button after glass refuse is collected in the bucket 39.

In addition, a timer may be set so that the glass refuse transferring portion 38 commences to drive roughly simultaneously with the glass refuse crushing portion 35 and it stops driving after the estimated time of transfer completion elapses in the glass refuse transferring portion 38 after the glass refuse crushing portion 35 stops driving. Also, a transfer driving switch (not illustrated) which can drive only the glass refuse transferring portion 38 may be provided. Thereby, it is possible to discharge crushed substances accumulated in the glass refuse transferring portion 38 by driving only the glass refuse transferring portion 38 after a crushing process is terminated by the glass refuse crushing portion 35.

Next, a description is given of a case of crushing empty cans. Also, a non-glass refuse crushing and processing apparatus 40 for cans is used when crushing empty cans, and a non-glass refuse crushing and processing apparatus 41 for plastic bottles is used when crushing empty plastic bottles. In this case, almost similar operations are carried out for crushing in both cases. Therefore, hereinafter, a description is given of a case of crushing empty cans, and a description of crushing plastic bottles is omitted.

As shown in FIG. 1 through FIG. 3, first, the opening and closing door 15b of the non-glass refuse inputting portion 15 is opened. Next, the non-glass refuse crushing and processing apparatus 40 is commenced to be driven by driving the conveyor drive portion (not illustrated), which drives the belt conveyor 20, and the non-glass refuse crushing driving portion, wherein the belt conveyor 20 is driven, and a plurality of rotary teeth 57a, 57b, 58a and 58b, which constitute the non-glass refuse crushing portion 44, are commenced to be driven. Empty cans inputted in the non-glass refuse inputting portion 15 are transferred by the belt conveyor 20 via the chute portion 50 and are inputted in the non-glass refuse supplying portion 42.

Empty cans supplied into the non-glass refuse crushing portion 44 via the non-glass refuse supplying portion 42 are entrained by the entraining rotary teeth 57a and 57b, sheared and crushed by the rotary crushing teeth 58a and 58b. Thereafter, the crushed substances are discharged to the transfer amount controlling portion 46 via the non-glass refuse crushed substance discharging port 55.

Here, the non-glass refuse crushing and processing apparatus 40 for cans according to Embodiment 1 may be an apparatus in which two entraining rotary teeth 57a and 57b having plate-shaped teeth, radially formed on a shaft rotated by the rotary teeth driving portion 59 from its center, disposed in plurality parallel to each other with clearance so that the section thereof becomes comb-like in the axial direction, are juxtaposed at the lower part of the non-glass refuse supplying port in the horizontal direction with prescribed clearance secured, and rotary crushing teeth 58a and 58b similar to the entraining rotary teeth are disposed so as to be engaged with each other at the lower part of the respective entraining rotary teeth 57a and 57b.

At this time, the entraining rotary teeth 57a and 57b are disposed so that non-glass refuse inputted from the non-glass refuse supplying portion 42 drops on the non-glass refuse crushing and processing portion 56 between the two entraining rotary teeth 57a and 57b, and the respective entraining rotary teeth 57a and 57b and rotary crushing teeth 58a and 58b rotate inwardly so as to entrain in the inputted non-glass refuse. Also, the inputted non-glass refuse is entrained by the entraining rotary teeth 57a and 57b and sheared by two rotary crushing teeth 58a and 58b disposed below the teeth 57a and 57b in engagement therewith, and crushed.

Crushed substances inputted into the transfer amount controlling portion 46 are further inputted into a metering portion 64 formed between two rotating wall portions 62, adjacent to each other, which rotate centering around the rotary shaft portion 61, and the crushed substances are moved to the lower side inside the transfer amount controlling portion 64 along with rotation of the rotating wall portions 62.

As the metering portion into which the crushed substances are inputted is moved to the lower side inside the transfer amount controlling portion 46, the metering portion communicates with the air exhausting tube 48a and crushed substance discharging tube 47, and are pneumatically conveyed to the refuse classifying/accommodating portion 13 via the crushed substances discharging tube 47 by air exhausted by the air discharging portion 48. Pneumatically conveyed non-glass refuse crushed substance are classified into aluminum scraps and steel scraps by the magnetic classifier 29 via the classified refuse connection tube 17 and classified refuse movable tube 18. The respective crushed substances are accommodated in the aluminum can accommodating portion 80 and steel can accommodating portion 81 via the aluminum can accommodating port 90 and steel can accommodating port 91.

Further, it is devised that only either one of the non-glass refuse crushing and processing apparatus 40 for cans, glass refuse crushing portion 35, or non-glass refuse crushing and processing apparatus 41 for plastic bottles can be driven, whereby the total power amount required to drive respective apparatuses can be reduced. Also, the respective apparatuses may be devised to be driven at the same-time.

Next, a description is given, herebelow, of discharge of refuse from the refuse classifying/accommodating portion 13 in the vehicle for classifying and collecting refuse according to Embodiment 1 with reference to the drawings.

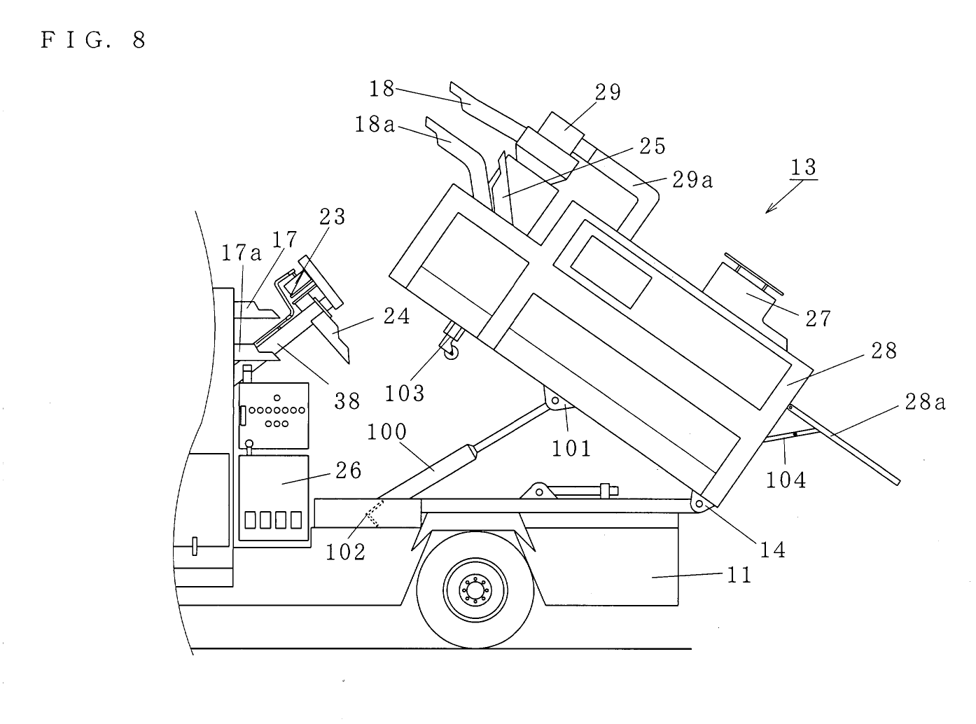

FIG. 8 is a side view of the major parts, showing a state where the refuse classifying/accommodating portion 13 is inclined with respect to the installation base 11, using the inclination apparatus portion 100 installed in the vehicle for classifying and collecting refuse 10 according to Embodiment 1.

In FIG. 8, an inclination apparatus portion 100 is composed of a piston and a cylinder. A piston supporting portion 101 axially supports the piston of the inclination apparatus portion 100 on the bottom portion of the refuse classifying/accommodating portion 13. An engagement portion 102 is formed of an elbow-shaped steel plate to fix the refuse classifying/accommodating portion 13 in a state where it is installed at the installation base 11. An engaged portion 103 is provided, at the tip end thereof, with a wheel portion rotating along the elbow-shaped engagement portion 102. A collapsible supporting metal fitting 104 fixes the opening and closing door 28a in an open state.

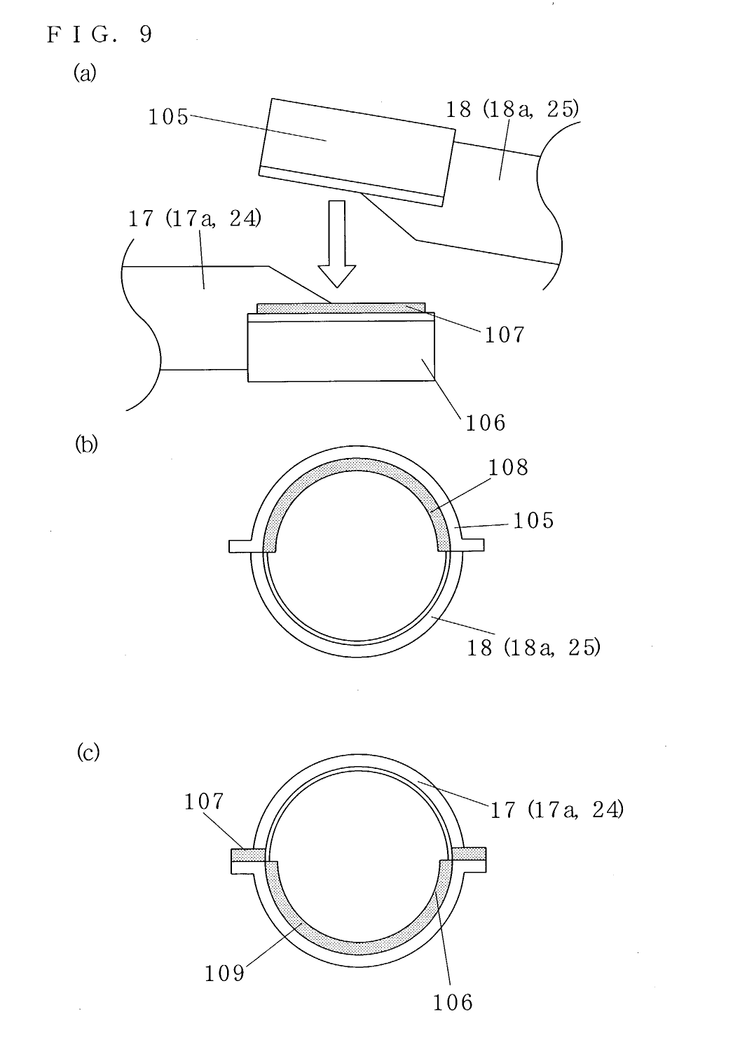

FIG. 9(a) is a side view of the major parts showing the glass refuse and classified refuse connection tubes and glass refuse and classified refuse movable tubes of a vehicle for classifying and collecting refuse according to Embodiment 1, FIG. 9(b) is a front view of the major parts of the glass refuse and classified refuse movable tubes of a vehicle for classifying and collecting refuse according to Embodiment 1, and FIG. 9(c) is a front view of the major parts showing the glass refuse and classified refuse connection tubes of a vehicle for classifying and collecting refuse according to Embodiment 1.

In FIG. 9, a movable tube cover portion 105 is disposed at the tip end portion of the glass refuse and classified refuse movable tubes 18 (18a and 25). A connection tube cover portion 106 is disposed at the tip end portion of the glass refuse and classified refuse connection tubes 17 (17a and 24). A cover portion damping member 107 made of rubber and synthetic resin (hereinafter called “rubber, etc.”) is disposed at the part to which the movable tube cover portion 105 of the connection tube cover portion 106 is attached. An upper part side damping member 108 made of rubber, etc., is disposed at the part to which the classified refuse connection tube 17 of the movable tube cover portion 105 is attached. A lower part side damping member 109 made of rubber, etc., is disposed at the part to which the movable tube 18 of the connection tube cover portion 106 is attached.

First, glass refuse, empty cans, and plastic bottles are crushed and processed through the respective operations described above by the glass refuse crushing portion 35, non-glass refuse crushing and processing-apparatus 40 for cans, and non-glass refuse crushing and processing apparatus 41 for plastic bottles, and crushed substances are classified and accommodated in the respective accommodating portions 73, 80, 81, and 82 to which respective discharging ports are connected. Here, it is possible to check the amounts of the crushed substances in the respective accommodating portions 73, 80, 81 and 82 from the outside through the window portion 28b, etc.

Next, as crushed substances are filled in the respective accommodating portions 73, 80, 81 and 82, the vehicle for classifying and collecting refuse 10 is moved to a processing station. The crushed substances in the respective accommodating portions 73, 80, 81 and 82 are discharged to processing yards for each classification in the processing station and are supplied for recycling. When the vehicle for classifying and collecting refuse arrives at a processing yard of glass refuse, the opening and closing door 76 of the glass refuse discharging port 74 is opened, and the door 76 is held in its open state by the supporting metal fitting 104. Next, the piston of the inclination apparatus portion 100, which constitutes the inclination apparatus portion, is pushed out with hydraulic drive power in the cylinder by operating the inclination apparatus operating portion 26, thereby-pushing up the refuse classifying/accommodating portion 13, wherein the refuse classifying/accommodating portion 13 is inclined, and glass refuse crushed substances in the glass refuse accommodating portion 73 are discharged from the opening portion 75.

At this time, as shown in FIG. 9, since the classified refuse movable tubes 18 (18a and 25) are separated from the classified refuse connection tubes 17 (17a and 24) to which the movable tubes 18 are connected, in line with inclination of the refuse classifying/accommodating portion 13, there is no need to manually remove the movable tubes 18 before commencing the discharging work, wherein it is possible to easily carry out discharging work. In addition, the refuse classifying/accommodating portion 13 is inclined to the installation base 11 side after the discharge of refuse is terminated, and is returned to a state where it is installed at the installation base. However, at this time, by providing the cover portion damping member 107, upper part side damping member 108, and lower part side damping member 109 at the respective fitting portions of the classified refuse connection tubes 17 (17a and 2.4) and the classified refuse movable tubes 18 (18a and 25), it is possible to relieve an impact when the classified refuse connection tubes 17 (17a and 24) are connected the classified refuse movable tubes 18 (18a and 25), and air leakage can be also prevented when carrying out pneumatic transfer.

Where discharging can-crushed substances in aluminum and steel can accommodating portions 80 and 81, the refuse classifying/accommodating portion 13 is inclined in a state where the opening and closing door 87 is held in its open state as in the case of discharging glass refuse crushed substances, and can-crushed substances are discharged through an opening portion 86. Also, where crushed substances in the plastic bottle accommodating portion 82 are discharged, the opening and closing door 87 of the plastic bottle accommodating portion 82 is opened as in the case of discharging the can-crushed substances, and plastic bottle crushed substances are discharged.

Next, a description is given of the magnetic classifier.

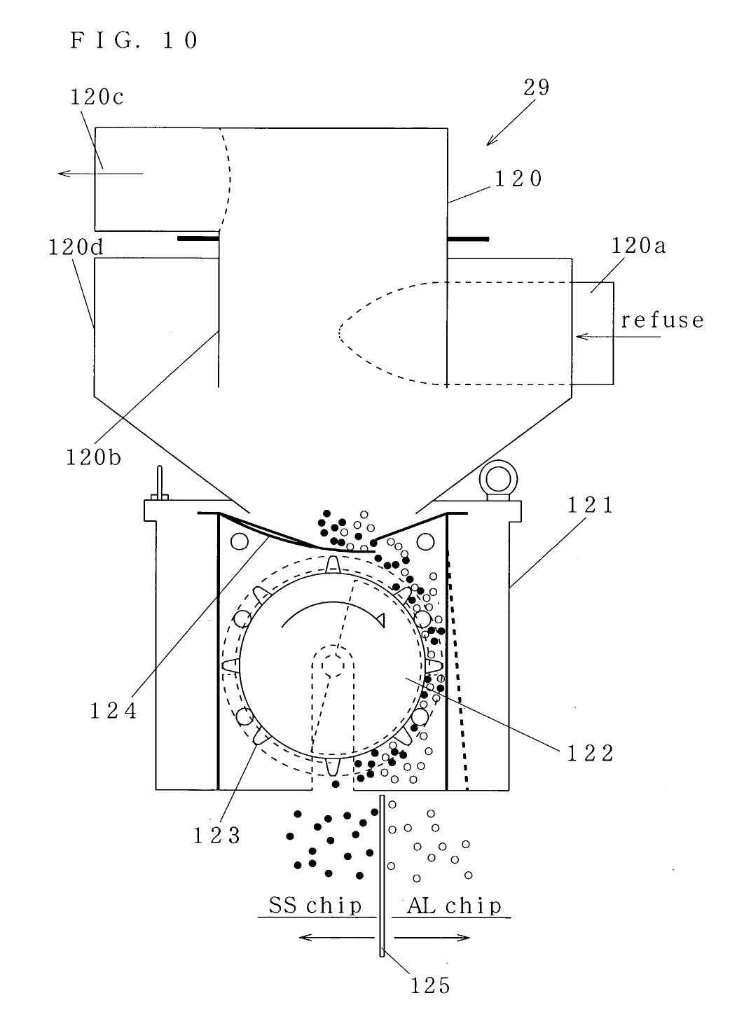

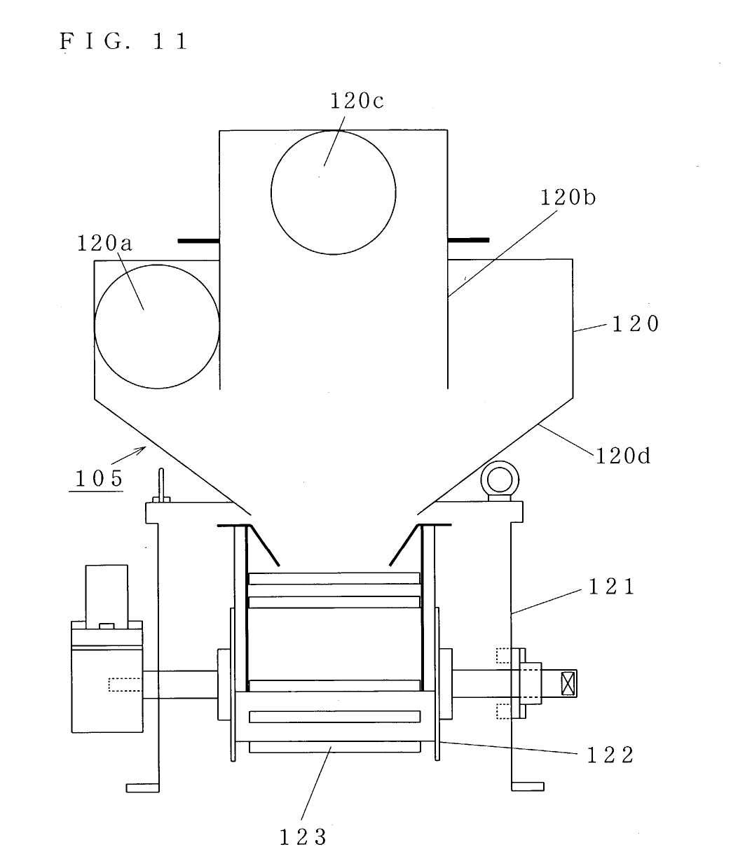

FIG. 10 is a sectional view of the major parts, showing the inner construction of the magnetic classifier, and FIG. 11 is a side sectional view showing the major parts thereof.

In the drawings, a cyclone portion 120 constitutes the magnetic classifier 29, in which refuse is supplied from the supplying portion 120a side in the tangential direction of the circumferential wall of the lower part, metal scraps crushed by rotation movement of flows are concentrated at the wall surface 120d side by a centrifugal force, exhaust air is collected by the inner cylinder 120b and is exhausted through the discharging port 120c. A magnet drum portion 121 places refuse, which is dropped from the lower part at the center of the cyclone portion 120, on the magnet drum 122, and moves the same, and separates the refuse at the lower part of the magnet drum 122 on the basis of differences in magnetism thereof. A protrusion portion 123 is formed on the surface of the magnet drum 122. A shielding rubber plate 124 guides refuse, which drops from the lower part of the cyclone portion 120, onto the magnet drum 122. A guiding plate 125 classifies steel scraps and aluminum scraps separately.

Also, the discharging port 120c is connected to the aluminum can accommodating portion 80 via the air exhaust portion 29a shown in FIG. 1, and air flown in along with refuse from the supplying portion 120a is exhausted through the air extractor 27a of the aluminum can accommodating portion 80. Also, aluminum scraps and steel scraps, which are classified by the magnetic classifier 29, are respectively accommodated into the aluminum can accommodating portion 80 and steel can accommodating portion 81 through the aluminum can accommodating port 90 and steel can accommodating port 91 of the refuse classifying/accommodating portion 13.

Where refuse is metallic substances, the substances are pneumatically conveyed by a metal crushing and processing apparatus, and are supplied into the magnetic classifier 29 via the classified refuse connection tube 17 and classified refuse movable tube 18. With respect to refuse in which aluminum scraps and steel scraps are mixed, crushed metal scraps are concentrated from the wall surface 120d to the lower part at the center portion of rotation by a rotation force of the cyclone portion 120, and are separated into steel scraps having a magnetic property and aluminum scraps having a non-magnetic property by the magnet drum portion 121 having the magnet drum 122. Here, aluminum scraps and steel scraps separated from each other are, respectively, classified and dropped in the aluminum can accommodating portion 80 and steel can accommodating portion 81.

Thus, respective refuse accommodated in the refuse classifying/accommodating portion 13 can be discharged, without being interfered by any surrounding arrangements, by causing the refuse classifying/accommodating portion 13 to be inclined with respect to the installation base 11 of a vehicle body, using the inclination apparatus portion 100, in a waste disposal site, etc.

Since the vehicle for classifying and collecting refuse according to Embodiment 1 is constructed as described above, the following actions can be brought about.

(1) Since the refuse processing apparatus portion and refuse classifying/accommodating portion are detachable, and the inclination apparatus portion is provided on the installation base at the driver's seat rear side, a vehicle for classifying and collecting refuse is able to go straight to a refuse processing facility when the refuse classifying/accommodating portion is filled with refuse, cause the refuse discharging port to be opened, and to incline the refuse classifying/accommodating portion by the inclination apparatus portion, and to discharge the refuse.

(2) Since the refuse processing apparatus portion is provided with a bucket conveyor that transfers buckets disposed at the outer wall side to an inputting opening provided with a guide portion disposed upward of the glass refuse inputting portion, glass pieces are prevented from being scattered when crushing glass refuse, and crushing and processing can be safely carried out. Simultaneously, since glass pieces are collected and conveyed by buckets, it is possible to save a great deal in operations and labor with respect to the transfer of glass bottles.

(3) Since the inputting portions for glass refuse or non-glass refuse are located at the left side of the vehicle (passenger seat) in the case where the vehicle body is for a left-hand side traffic system or at the right side of the vehicle (passenger seat) in the case where the vehicle body is for a right-hand side traffic system, a worker seated in the front passenger seat easily gets out and is able to carry out collection work, wherein high operation efficiency can be secured.

(4) With glass refuse crushing and processing apparatus, the glass refuse (empty bottles, plastic hangers (excluding metallic fittings), trays, styrene foam) is inputted, crushed, and conveyed or transferred, the processed substances thereof can be accommodated in the glass refuse accommodating portion of the refuse classifying/accommodating portion. In particular, where the transferring apparatus is provided with a screw conveyor, the grain size of the substances crushed by the glass refuse crushing portion can be made further smaller while being transferred by screws of the screw conveyor.

(5) Where the respective crushing drive portions and transfer driving portion are formed of a hydraulic motor using P.T.O of the vehicle as its drive source, no electric generator is required, wherein the entire system can be made remarkably compact in comparison with a case of using an electric motor, wherein the refuse processing apparatus portion can be attempted to be compact.

(6) Since an air discharging portion, which is provided in respective crushing and processing apparatuses for cans and plastic bottles, is provided, processed substances of cans and plastic bottles are crushed by the non-glass refuse crushing portion, and crushed substances can be blown and discharged by the air discharging portion, wherein no other large-sized transfer equipment is required for discharge of crushed substances, and the refuse processing apparatus portion can be made compact.

(7) Since glass refuse, empty cans and plastic bottles can be classified, crushed and processed by the refuse processing apparatus portion, and simultaneously, the crushed substances can be classified and accommodated in the refuse classifying/accommodating portion, glass refuse, empty cans and plastic bottles can be classified and collected by a simplified structure without becoming bulky, since the refuse does not become bulky because it is crushed and collected. Therefore, a great deal of cans, etc., can be collected at once, wherein efficiency in the collection work can be improved.

(8) Since the inclination apparatus portion is provided, the refuse classifying/accommodating portion is inclined over the repose angle in response to the types of glass refuse or non-glass refuse, wherein work efficiency in discharge can be improved.

(9) Since the respective opening and closing doors of the refuse classifying/accommodating portion are provided with portions to be engaged, and are also provided with supporting metal fittings to be engaged in the engaged portion when the door is held in an open state, the door can be prevented from being closed when discharging crushed substances from the respective accommodating portions, and it is possible to securely discharge the crushed substances from the respective accommodating portions in safely.

(10) Since windows are formed in the upper wall and side wall of the respective accommodating portions, it is possible to check the interior of the respective accommodating portions from outside, and it is possible to confirm the amount of crushed substances accommodated in the respective accommodating portions, wherein it is possible to easily check whether or not the refuse classifying/accommodating portion is required to be replaced.

(11) Since can and plastic bottle discharging ports of the refuse processing apparatus portion are connected to the respective classified refuse inputting ports of the refuse classifying/accommodating portion, and the glass refuse discharging port of the refuse processing apparatus portion is connected to the glass refuse accommodating port of the refuse classifying/accommodating portion, it is possible to easily attach and detach the refuse processing apparatus portion and refuse classifying/accommodating portion.

(12) Since an air extractor is provided, substances crushed by the respective crushing and processing apparatus for cans and plastic bottles can be blown and be accommodated in the respective classified refuse accommodating containers.

(13) Since a soundproof member is disposed at the housing of the refuse processing apparatus portion, noise of the respective crushing apparatuses disposed in the refuse processing apparatus portion can be effectively suppressed, wherein use efficiency thereof can be improved.

(14) Since an inspection door is provided at the housing of the refuse processing apparatus portion, maintenance efficiency of the respective crushing apparatuses disposed in the refuse processing apparatus portion can be improved.

(15) Since the vehicle for classifying and collecting refuse is provided with a magnetic classifier, which is able to separate steel having a magnetic property from aluminum and plastics having a non-magnetic property, between the refuse processing apparatus portion and refuse classifying/accommodating portion, subsequent refuse processing can be individually carried out on the basis of respective characteristics and values thereof, wherein the system is economical, and the processing operation can be efficiently carried out.

(16) Since the refuse classifying/accommodating portion is sectioned into four chambers, which are able to accommodate substances that are classified and processed by metals, plastics, glass refuse, etc., refuse processing can be further efficiently carried out.

Further, a refuse processing apparatus portion 12 according to Embodiment 1 is provided with one glass refuse processing apparatus and two non-glass refuse processing apparatus portions. However, the apparatus 12 is not limited thereto. The apparatus 12 may be provided with two glass refuse processing apparatuses and two non-glass refuse processing apparatus portions. The number thereof may adequately be selected on the basis of the size of a vehicle.

What is claimed is:

1. A vehicle for classifying and collecting refuse, comprising:
a vehicle body having, at the rear part thereof, an installation base on which apparatuses are installed;
a refuse processing apparatus portion, which is installed at the installation base for classifying, and crushing or compacting (reducing the capacity) one or more types of refuse of glass refuse, metals such as empty cans, plastics such as plastic bottles, which are supplied through a refuse inputting portion;
a refuse classifying/accommodating portion, which is inclinably installed at the rear part of the refuse processing apparatus portion on the installation base, for classifying and accommodating the refuse crushed or compacted by the refuse processing apparatus portion;
a refuse discharging port formed at the rear side or the side of the refuse classifying/accommodating portion; and
an inclination apparatus portion for inclining the refuse classifying/accommodating portion toward the rear side or the side of the vehicle body.

2. The vehicle for classifying and collecting refuse as set forth in claim 1, wherein said refuse processing apparatus portion is provided with said refuse inputting portion at the left side of said vehicle body in the case where said vehicle body is for a left-hand side traffic system or at the right side of said vehicle body in the case where said vehicle body is for a right-hand side traffic system.

3. The vehicle for classifying and collecting refuse as set forth in claim 1 or 2, wherein said refuse processing apparatus portion comprises one or more glass refuse processing apparatuses for crushing or compacting glass refuse, and/or one or more non-glass refuse processing apparatus portions for crushing or compacting metals such as empty cans or plastics such as plastic bottles, etc.

4. The vehicle for classifying and collecting refuse as set forth in any one of claims 1 through 3, wherein said refuse classifying/accommodating portion includes: a glass refuse accommodating portion for accommodating glass refuse substances processed by said glass refuse processing apparatus; a glass refuse accommodating port formed at the upper wall or sidewall of said glass refuse accommodating portion, into which said glass refuse processed substances are supplied; a glass refuse discharging port formed at the side wall or the rear part wall of said glass refuse accommodating portion; one or more classified refuse accommodating portions for classifying and accommodating non-glass refuse processed substances such as empty cans and plastic bottles, etc., which are processed by said non-glass refuse processing apparatus portion; a classified refuse accommodating port formed at the side wall or the upper wall of said classified refuse accommodating portion, into which said non-glass refuse processed substances are supplied; and a classified refuse discharging port formed at respective side walls or the respective rear side-wall of said classified refuse accommodating portion.

5. The vehicle for classifying and collecting refuse as set forth in any one of claims 1 through 4, wherein said refuse classifying/accommodating portion includes one or more glass refuse accommodating portions and/or one or more classified refuse accommodating portions, which are sectioned and formed in parallel to or orthogonal to the advancement direction of said vehicle body.

6. The vehicle for classifying and collecting refuse as set forth in claims 3 through 5, wherein said glass refuse processing apparatus comprises: a glass refuse crushing portion; a glass refuse crushed substance discharging port formed to be roughly funnel-like at the lower part of said glass refuse crushing portion; a glass refuse supplying portion formed at the upper part of said glass refuse crushing portion; a glass refuse inputting portion opened at the upper part or side wall of said refuse processing apparatus portion and communicating with said glass refuse supplying portion; and a glass refuse transfer portion communicating with said glass refuse crushed substance discharging port, the discharging port side of which is connected to said glass refuse accommodating port of said glass refuse accommodating portion of said refuse classifying/accommodating portion.

7. The vehicle for classifying and collecting refuse as set forth in claim 6, wherein said refuse processing apparatus portion comprises a bucket into which glass refuse is inputted through said glass refuse inputting portion and a bucket conveyor for transferring said-bucket to said glass refuse supplying portion.

8. The vehicle for classifying and collecting refuse as set forth in claim 6 or 7, wherein said glass refuse transferring portion comprises a glass refuse connection tube communicating with said glass refuse crushed substance discharging port and disposed at the rear side of said refuse processing apparatus portion; a glass refuse movable tube communicating with said glass refuse accommodating portion, set and fixed at the front side of said refuse classifying/accommodating portion, and connected to the tip end portion of said connection tube by being brought into contact with the tip end portion of said connection tube when said refuse classifying/accommodating portion is installed at said installation base.

9. The vehicle for classifying and collecting refuse as set forth in claim 8, wherein said glass refuse connection tube, said glass refuse movable tube, said classified refuse connection tube and: said classified refuse movable tube comprise: covering portions disposed at the tip end portion of said glass refuse connection tube and said classified refuse connection tube and/or said glass refuse movable tube and said classified refuse movable tube; a covering portion damping member dispose data fitting part between said covering portions; a tubular part damping member disposed at a fitting part between said covering portions and said connection tube or said movable tube.

10. The vehicle for classifying and collecting refuse as set forth in any one of claims 3 through 9, wherein said non-glass refuse processing apparatus portion comprises: a non-glass refuse crushing portion; a non-glass refuse crushed substance discharging port formed to be roughly funnel-like at the lower part of said non-glass refuse crushing portion; a non-glass refuse supplying portion formed at the upper part of said non-glass refuse crushing portion; a non-glass refuse inputting portion opened at the upper part or side wall of said refuse processing apparatus portion and communicating with said non-glass refuse supplying portion; and a non-glass refuse transferring portion communicating with said non-glass refuse crushed substance discharging port, the discharging port side of which is connected to said classified refuse accommodating port of said classified refuse accommodating portion of said refuse classifying/accommodating portion.

11. The vehicle for classifying and collecting refuse as set forth in claim 10, wherein said refuse processing apparatus portion comprises a non-glass refuse transferring portion that connects said non-glass refuse inputting portion to said non-glass refuse supplying portion and transfers non-glass refuse inputted by said non-glass refuse inputting portion to said non-glass refuse supplying portion.

12. The vehicle for classifying and collecting refuse as set forth in claim 10 or 11, wherein said non-glass refuse transferring portion comprises a classified refuse connection tube communicating with said non-glass crushed substance discharging port and disposed at the rear side of said refuse processing apparatus portion; a classified refuse movable tube communicating with said non-glass refuse accommodating portion, set and fixed at the front side of said refuse classifying/accommodating portion, and connected to said classified refuse connection tube by being brought into contact with or proximate to said classified refuse connection tube when said refuse classifying/accommodating container is installed at said installation base.

13. The vehicle for classifying and collecting refuse as set forth in anyone of claims 4 through 12 wherein said classified refuse accommodating portion comprises: an air extractor communicating with the outside of said refuse classifying/accommodating portion, and/or a ventilation portion communicating with classified refuse accommodating portions adjacent to each other.

14. The vehicle for classifying and collecting refuse as set forth in any one of claims 10 through 13, further including a magnetic classifier connected to said non-glass refuse transferring portion, wherein said refuse classifying/accommodating portion includes a magnetic substance accommodating portion and a non-magnetic substance accommodating portion, into which non-glass refuse processed substances discharged from said non-glass refuse crushing portion are magnetically classified and are respectively inputted.
